(19) United States
(12) Patent Application Publication
(10) Pub. No.: US 2025/0227453 A1
(43) Pub. Date: Jul. 10, 2025

(54) METHOD AND DEVICE FOR PROCESSING ENABLED PROFILE IN CLOSED PORT

(71) Applicant: SAMSUNG ELECTRONICS CO., LTD., Suwon-si, Gyeonggi-do (KR)

(72) Inventors: Sujung KANG, Suwon-si (KR); Kangjin YOON, Suwon-si (KR); Duckey LEE, Suwon-si (KR)

(21) Appl. No.: 18/846,984

(22) PCT Filed: Mar. 16, 2023
(86) PCT No.: PCT/KR2023/003512

§ 371 Date: Sep. 13, 2024

(30) Foreign Application Priority Data
Mar. 16, 2022 (KR) 10-2022-0032908
Mar. 25, 2022 (KR) 10-2022-0037313

(51) Int. Cl. H04W 8/18; H04W 8/20; H04W 8/22

(52) U.S. Cl. CPC H04W 8/183; H04W 8/20; H04W 8/22

(57) ABSTRACT

The disclosure relates to a 5G or 6G communication system for supporting a higher data transmission rate. The present disclosure relates to a method and a device for processing an enabled profile in a closed port, wherein when a terminal and an eUICC support simultaneous activation (MEP) of multiple profiles by using a logical interface, the terminal and the eUICC complete an initialization process with reference to the number of profiles in an enabled state in the eUICC, and then configure the terminal and/or the eUICC according to a configured scheme, thereby avoiding user confusion.

### TECHNICAL FIELD

The disclosure relates to a method of processing an enabled profile when using a logical interface between a terminal and a universal integrated circuit card (UICC) in a wireless communication system.

### RELATED ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A universal integrated circuit card (UICC) is a smart cart that is used by inserting into a terminal, for example, a mobile communication terminal, and is also referred to as a UICC card. The UICC may include an access control module for accessing a network of a mobile communication provider. Examples of the access control module include a universal subscriber identity module (USIM), a subscriber identity module (SIM), an Internet protocol multimedia service identity module (ISIM).

A UICC that includes a UISM is generally called a USIM card. Likewise, a UICC that includes a SIM is typically called a SIM card. In the following description, it should be noted that the term “SIM card” may be used in the general sense including a UICC card, a USIM card, and a UICC including an ISIM. Of course, even though it is a SIM card, its technical application may be equally applied to a USIM card, an ISIM card, or a general UICC card.

The SIM card stores personal information of a mobile communication subscriber and performs subscriber authentication and traffic security key generation when accessing a mobile communication network to enable the safe use of mobile communication.

The SIM card is generally manufactured as a dedicated card for a specific mobile communication provider in response to a request from the specific mobile communication provider when manufacturing the SIM card, and authentication information for network access of the corresponding provider, for example, universal subscriber identity module (USIM) application, international mobile subscriber identity (IMSI), K value, OPc value, and the like, are preloaded before shipping. Therefore, the manufactured SIM card is supplied to the corresponding mobile communication provider and then provided to a subscriber and, afterwards, if necessary, management such as installation, modification, and deletion of an application within the UICC may be performed using technology such as Over The Air (OTA).

A subscriber may use a network and an application service of the corresponding mobile communication provider by inserting the UICC card into the subscriber's mobile communication terminal. When replacing the mobile communication terminal, the subscriber may move the UICC card from the existing mobile communication terminal and insert the same into a new mobile communication terminal and may use authentication information, mobile communication phone number, personal phone book, and the like, stored in the UICC card as is in the new mobile communication terminal.

However, the SIM card has some inconvenience in allowing the user of the mobile communication terminal to receive services of other telecommunication companies. The user of the mobile communication terminal has inconvenience of having to physically acquire the SIM card to receive a service from the mobile communication provider. For example, when traveling to another country, there is the inconvenience of having to acquire a local SIM card to receive a local mobile communication service. A roaming service may solve the inconvenience to some extent, but there are also issues, such as high fee and inability to receive a service if there is no contract between telecommunication companies.

Meanwhile, if the SIM module is remotely downloaded and installed on the UICC card, much of the above inconvenience may be resolved. For example, the user may download a SIM module of a mobile communication service the user desires to use to the UICC card at the user's desired point in time. This UICC card may download and install a plurality of SIM modules and may select and use only one SIM module from among them. This UICC card may be fixed or may not be fixed to a terminal. A UICC that is fixed to a terminal and used is called an embedded UICC (eUICC). Typically, the eUICC refers to the UICC card that is fixed to the terminal and may remotely download and select a SIM module. In the disclosure, the UICC card capable of remotely downloading and selecting the SIM module is collectively referred to as the eUICC. Among UICC cards capable of downloading and selecting the SIM module, the UICC card fixed to the terminal and the UICC card not fixed to the terminal are collectively referred to as the eUICC. Also, downloaded SIM module information is collectively termed profile.

Although one or more profiles are present within the eUICC, only one profile may be simultaneously activated (enabled). Therefore, although the terminal supports two or more basebands and two or more profiles are present within the eUICC, the terminal does not support a dual SIM function that allows two profiles to be simultaneously available on one mobile phone. As a method to resolve this, there is a need for multiple enable profiles (MEP) that allow one or more profiles to be present within the eUICC and allow one or more profiles to be simultaneously enabled.

However, when supporting MEP between the terminal and the eUICC, selection of an approach from the terminal to Issuer Security Domain Root (ISD-R) that processes a profile management command within the eUICC and an operation to be processed by the terminal or the eUICC according to the decision are not currently defined. A local profile assistant (LPA) that is an eUICC control application of the terminal transmits, to the ISD-R of the eUICC, a command including an integrated circuit card ID (ICCID), which is an ID of a management target profile, in the profile management command to be transmitted. The eUICC that receives the command processes the profile management command for the ICCID and transmits the occurrence of a profile status change or an overall status change of the eUICC to a terminal modem, such that the terminal modem performs a necessary procedure according to the corresponding command transmission. In general, since one baseband of the terminal modem is connected to (one profile of) one eUICC through one physical interface, there is no need to consider baseband mapping when processing a command for a profile. However, in the case of supporting MEP, a plurality of basebands is present in the terminal, a plurality of profiles is present in the eUICC, a plurality of eSIM ports (eSIM Port is used as a term to indicate one physical interface, as described below) is present between the terminal and the eUICC. Therefore, a method of transmitting and processing a profile management message between the terminal and the eUICC considering all of this needs to be devised.

### DETAILED DESCRIPTION

### Technical Subject

In general, a wireless communication system considers a method of handling initialization between a terminal and an embedded universal integrated circuit card (UICC) with the assumption that both the terminal and the eUICC may activate, that is, enable only one profile in the eUICC at the same time. A method of simultaneously enabling two or more profiles in one eUICC has been discussed, and a method of providing a logical interface for the same such that messages may be exchanged between the terminal and the profiles of the eUICC is under discussion. Accordingly, the present invention proposes a method of processing the status of a profile and a logical interface in consideration of connection relationship between the profile and the logical interface.

### Technical Solution

A method of performed by a terminal in a wireless communication system according to an embodiment of the disclosure to solve the above-described issues may include in case that the terminal supports multiple enabled profiles (MEP), identifying the number of ports supportable between the terminal and an embedded universal integrated circuit card (eUICC), identifying the number of enabled profiles among a plurality of profiles of the eUICC, if the verified number of ports is less than the number of enabled profiles, determining to disable at least one profile among the enabled profiles; and delivering a command to disable the at least one profile to the eUICC.

A terminal in a wireless communication system according to another embodiment of the disclosure may include: a transceiver, and a controller configured to, in case that the terminal supports MEP, identify the number of ports supportable between the terminal and an eUICC, to identify the number of enabled profiles among a plurality of profiles of the eUICC, to if the verified number of ports is less than the number of enabled profiles, determine to disable at least one profile among the enabled profiles, and to deliver a command to disable the at least one profile to the eUICC.

### Effect

According to embodiments of the present invention, a terminal may improve user convenience by simultaneously using a plurality of profiles. The terminal may construct and provide information on availability of an accurate profile to a user.

### BRIEF DESCRIPTION OF DRAWINGS

FIG. 1 is a diagram illustrating components of a wireless communication system according to an embodiment of the disclosure.

FIG. 2 schematically illustrates an example of connection between a modem and a v2 embedded universal integrated circuit card (eUICC) not supporting multiple enabled profiles (MEP) in a wireless communication system according to an embodiment of the disclosure.

FIG. 3A illustrates an Issuer Security Domain Root (ISD-R) approach between an eUICC and a modem according to introduction of a virtual interface concept in a wireless communication system according to an embodiment of the disclosure.

FIG. 3B illustrates an ISD-R approach between an eUICC and a modem according to introduction of a virtual interface concept in a wireless communication system according to an embodiment of the disclosure.

FIG. 3C illustrates an ISD-R approach between an eUICC and a modem according to introduction of a virtual interface concept in a wireless communication system according to an embodiment of the disclosure.

FIG. 4 illustrates an operation of determining a handling method for the number of ports to be used for an enabled profile in a terminal and an enabled profile in a closed port with reference to information on the number of supportable ports and enabled profiles collected from an eUICC during a terminal-card initialization process according to an embodiment of the disclosure.

FIG. 5 illustrates an operation of determining a handling method for the number of ports to be used for an enabled profile in a terminal and an enabled profile in a closed port with reference to information on the number of supportable ports and enabled profiles collected from an eUICC during a terminal-card initialization process according to another embodiment of the disclosure.

FIG. 6 is a diagram schematically illustrating an internal structure of a terminal in a wireless communication system according to embodiments of the disclosure.

FIG. 7 is a flowchart illustrating a possible operation in case that an eUICC is an eUICC that does not support profile enabling in a closed port according to another embodiment of the disclosure.

FIG. 8 is a flowchart illustrating a possible operation when an eUICC is an eUICC that does not support profile enabling in a closed port according to another embodiment of the disclosure.

### MODE FOR DISCLOSURE

Hereinafter, the operating principle of the disclosure is described in detail with reference to the accompanying drawings. When it is determined that a detailed description of related known functions or configurations may unnecessarily obscure the gist of the disclosure in describing the disclosure in the following, the detailed description will be omitted. The terms that are described below are terms defined in consideration of the functions in the disclosure, and may be different according to users, intentions of the users, or customs. Therefore, the definitions of the terms should be made based on the contents throughout the specification. Similarly, in the drawings, some components may be exaggerated, omitted, or schematically illustrated. Also, the size of each component does not completely reflect the actual size. In the drawings, identical or corresponding components are provided with identical reference numerals. The advantages and features according to the disclosure and methods to achieve them will be apparent with reference to embodiments as described below in detail in conjunction with the accompanying drawings. However, the disclosure is not limited to the embodiments set forth below, but may be implemented in various different forms. The following embodiments are provided only to completely disclose and inform those skilled in the art of the scope of the disclosure, and the appended claims. Throughout the specification, the same or like reference numerals designate the same or like components. Also, in describing the disclosure, a detailed description of known functions or configurations incorporated herein will be omitted when it is determined that the description may make the subject matter of the disclosure unnecessarily unclear. The terms that are described below are terms defined in consideration of the functions in the disclosure, and may be different according to users, intentions of the users, or customs.

In the following description, a base station is an entity that allocates resources to a terminal, and may be at least one of a gNode B, an eNode B, a Node B, a BS, a wireless access unit, a BS controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio transmission link through which a base station transmits a signal to a terminal, and an “uplink” refers to a radio transmission link through which a terminal transmits a signal to a base station. Also, although the following description may be directed to a long term evolution (LTE) or LTE-A system by way of example, embodiments of the disclosure may also be applied to other communication systems having similar technical backgrounds or channel types to the embodiments of the disclosure. Examples of other communication systems may include 5G mobile communication technology (5G, new radio (NR)) developed beyond LTE-A, and in the following description, “5G” may be a concept that covers exiting LTE, LTE-A, and other similar services. In addition, based on judgement by those skilled in the art, the disclosure may be applied to other communication systems through some modifications without significantly departing from the scope of the disclosure. Here, it will be understood that each block of flowchart illustrations and combinations of blocks in the flowchart illustrations may be implemented by computer program instructions.

These computer program instructions may be provided to a processor of a general-purpose computer, special purpose computer, or other programmable data processing apparatus, such that the instructions, executed via the processor of the computer or other programmable data processing apparatus, generate a method for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction implies that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions executed on the computer or other programmable apparatus provide steps for implementing the functions specified in the flowchart block(s).

Also, each block may represent a module, a segment, or a portion of code, which includes one or more executable instructions for implementing the specified logical function(s). It should also be noted that in some alternative implementations, the functions noted in the blocks may occur out of order. For example, two blocks shown in succession may in fact be executed simultaneously or the blocks may sometimes be executed in the reverse order, depending on the functionality involved. Here, the term “unit” used herein refers to a software component or a hardware component, such as a field programmable gate array (FPGA) or an application specific integrated circuit (ASIC), which performs a predetermined function. However, the term “unit” does not always have a meaning limited to software or hardware. “Unit” may be configured either to be stored in an addressable storage medium or to execute one or more processors. Therefore, “unit” includes, for example, components such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by “units” may be combined into a smaller number of components and “units,” or further divided into additional components and “units.” In addition, the components and “units” may be implemented to reproduce one or more CPUs within a device or a security multimedia card. Also, the term “unit” in the embodiments may include one or more processors.

Initially, terms used in the disclosure are defined.

In the disclosure, a UICC is a smart card that is inserted into a mobile communication terminal and refers to a chip that stores a mobile communication subscriber's network access authentication information, phone book, and personal information such as SMS to perform subscriber authentication and traffic security key generation when accessing a mobile communication system, such as global system for mobile communication (GSM), wideband code division multiple access (WCDMA), long term evolution (LTE), 5G, and the like, and to enable safe use of mobile communication. The UICC is equipped with communication applications such as a subscriber identity module (SIM), universal SIM (USIM), IP multimedia SIM (ISIM), etc., depending on a type of mobile communication network a subscriber connects to, and may also provide a high-level security function for mounting various applications such as electronic wallet, ticketing, and electronic passport.

In the disclosure, an embedded UICC (eUICC) is not limited to a security module built in a terminal and includes a removable security module that may insert into and remove from the terminal. The eUICC may download and install a profile using Over The Air (OTA) technology. The eUICC may be named a UICC that allows profile download and installation.

In the disclosure, a method of downloading and installing a profile on eUICC using OTA technology may also be applied to a removable UICC that may insert into and remove from a terminal, as described above. For example, an embodiment of the disclosure may be applied to the removable UICC capable of downloading and installing a profile using OTA technology.

In the disclosure, the terms “UICC” and “SIM” may be interchangeably used, and the terms “eUICC” and “eSIM” may be interchangeably used.

In the disclosure, a profile may indicate packaging of an application, a file system, an authentication key value, etc., stored in the UICC in software form. Also, the profile may be referred to as access information.

In the disclosure, a USIM profile may have the same meaning as a profile or may indicate packaging of information included in a USIM application within the profile in software form.

In the disclosure, a profile server refers to a server that may provide a function of generating a profile, encrypting the generated profile, generating a profile remote management command, or encrypting the generated profile remote management command, or may include a function of supporting activation of a plurality of profiles on a terminal and may include Subscription Manager Data Preparation (SM-DP), Subscription Manager Data Preparation plus (SM-DP+), and Subscription Manager Secure Routing.

The term “terminal” or “device” used herein may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various embodiments of the terminal may include a cellular phone, a smartphone with a wireless communication function, a personal digital assistant (PDA) with a wireless communication function, a wireless modem, a portable computer with a wireless communication function, a photographing device such as a digital camera with a wireless communication function, a gaming device with a wireless communication function, music storage and playback home appliances with a wireless communication function, and Internet home appliances capable of performing wireless Internet access and browsing and also portable units or terminals that integrate combinations of such functions. Also, the terminal may include a machine-to-machine (M2M) terminal and a machine type communication (MTC) terminal/device, but is not limited thereto. In the disclosure, the terminal may also be referred to as an electronic device or simply a device.

In the disclosure, the terminal or the device may include software or application installed on the terminal or the device to control a UICC or an eUICC. The software or the application may also be referred to as, for example, a local profile assistant (LPA). Herein, an eUICC identifier (eUICC ID) may be a unique identifier of the eUICC built in the terminal and may also be referred to as EID.

In the disclosure, an application protocol data unit (APDU) may be a message for interaction between a controller within the terminal or the device and the eUICC. The APDU is a pair of command and response, and APDU command and APDU response are defined in ETSI 102.221 with reference to ISO 7816. As defined in ETSI 102.221, the APDU command has a structure of Class of Instruction (CLA), Instruction (INS), Instruction Parameter 1 (P1), and Instruction Parameter 2 (P2) as a header of the APDU, and the number of bytes in the command data field (Lc), Data, and the number of bytes expected in response of the command (Le) as a body of the APDU, and the APDU response has the structure of Optional Data field, Status byte 1 (SW1), and Status byte 2 (SW2). For detailed description related thereto, refer to the ETSI 102.221 standard.

In the disclosure, the term “profile package” may be interchangeable used with a profile, or may be used as a term that indicates a data object of a specific profile and may also be referred to as a profile tag, length, value (TLV) or a profile package TLV. A profile identifier may be referred to as an ICCID, which is a unique identification number of a profile. If the profile package is encrypted using an encryption parameter, the profile package may be named a protected profile package (PPP) or a protected profile package TLV (PPP TLV). If the profile package is encrypted using an encryption parameter that may only be decrypted by a specific eUICC, it may be named a bound profile package (BPP) or a bound profile package TLV (BPP TLV). The profile package TLV may be a data set that represents information constituting the profile in a tag, length, value (TLV) format.

In the disclosure, AKA may represent Authentication and Key agreement and may represent an authentication algorithm for accessing 3GPP and 3GPP2 networks. K denotes an encryption key value stored in the eUICC used for the AKA authentication algorithm and, herein, OPc denotes a parameter value that may be stored in the eUICC used for the AKA authentication algorithm.

In the disclosure, NAA represents a network access application and may be an application such as a USIM or an ISIM that is stored in a UICC to access a network. The NAA may be a network access module.

In the disclosure, terms, “end user,” “user,” “subscriber,” “service subscriber,” and “user” may be interchangeably used with a user of a corresponding terminal.

In the disclosure, an eSIM port refers to a virtual interface that multiplexes and divides a physical interface connected to eUICC-modem, and may be interchangeably used with an eSIM port, a port, a SIM port, an ePort, ePort, an eSIM port, a logical interface, and logical SE interface (LSI). In the present invention, the logical interface may be described as a logical interface that is generated between a terminal and a card (eUICC or card other than eUICC) encompassing the eSIM port.

The eSIM port used by ISD-R may be expressed as an ISD-R eSIM port and the eSIM port used by the profile may be classified and used as a profile eSIM port.

In the disclosure, information on a profile that may be returned to LPA through GetProfileInfo( ) may be used as the term profile metadata or profile information. Corresponding information may be information of a profile provided when SM-DP+ installs the profile on the terminal, status or configuration information of the profile processed by the eUICC upon receiving an ES10c command from the LPA, or status/configuration of the profile processed when the eUICC satisfies a specific condition.

In the disclosure, a function of enabling and managing a plurality of profiles present in a single eUICC is collectively referred to as a multiple enabled profile (MEP) function. The conventional eUICC may only enable a maximum of one profile, so a single eUICC does not support a dual SIM function or a multi SIM function. To support the dual SIM function or the multi SIM function with a single eUICC, the single eUICC requires a function of enabling and managing a plurality of profiles. An eUICC in which the MEP function is implemented may be referred to as a MEP support eUICC. A terminal that includes modem in which the MEP function is implemented and terminal software capable of supporting the same, for example, the LPA may be referred to as a MEP support terminal.

In the disclosure, a mode in which at least one logical interface may be multiplexed and transmitted to be available in a single physical interface through a terminal-eUICC initialization process may be referred to as a MEP mode. It should be noted that even the MEP support terminal or the MEP support eUICC does not operate in the MEP mode if an operation in the MEP mode is not determined in the initialization process between the UE and the eUICC. When operating in the MEP mode, it may be referred to as a single enabled profile (SEP) mode.

Also, in describing the disclosure, a detailed description of relevant known functions or configurations will be omitted when it is determined that the description may make the gist of the disclosure unnecessarily unclear.

Hereinafter, embodiment(s) proposed in the disclosure are described with reference to the drawings.

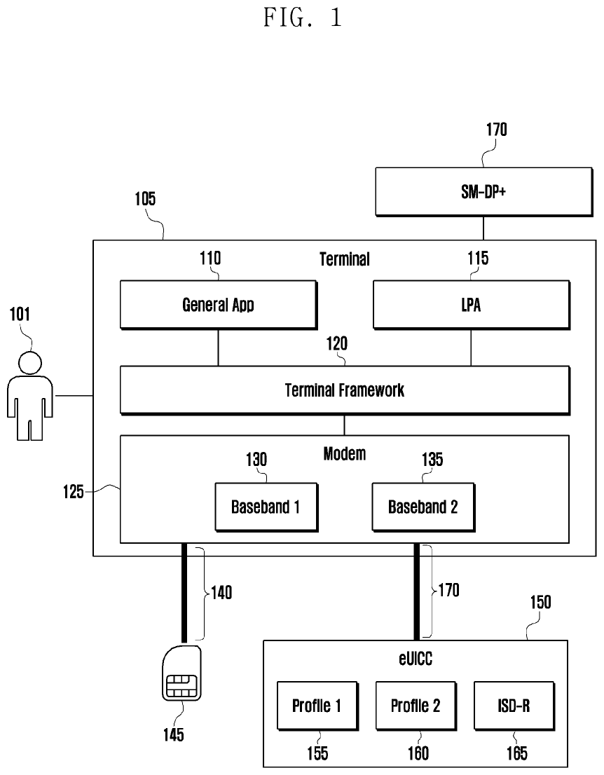

FIG. 1 is a diagram illustrating components of a wireless communication system according to an embodiment of the disclosure.

A terminal 105 may include a general app 110, an LPA 115, a terminal framework 120, a MEP support modem 125. Here, the general app 110 refers to an app that is pre-loaded or downloaded and installed on the terminal, such as telecommunication company provider app or a SIM card manager app, and may represent an app with access right to a profile of a physical SIM (pSIM) card 145 or an eUICC 150. Meanwhile, the LPA 115 refers to an app in charge of controlling the eUICC 150, and may process profile management while communicating with SM-DP+ 170, a terminal user 101, and an ISD-R 165 within the eUICC 150. The LPA 115 may be implemented alone or integrally implemented in another general terminal application. The LPA 115 may acquire a user input for local management of the profile by configuring a user interface (UI) or may acquire the user 101 input by receiving an SM-DP+ 170 remote management command from the SM-DP+ server 170 and then configuring a UI for the corresponding command, and then may deliver the profile management command from the LPA 115 to the ISD-R 165 of the eUICC 150 to process enable/disable/delete/update of the profile.

Even when the LPA 115 is implemented alone or integrated into another general terminal application (e.g., when classification of a SIM card manager app is not required), the LPA 115 is expressed as an LPA in the present invention. Remote profile management (RPM) refers to a series of procedures in which profile install/enable/disable/delete, and other functions are performed in response to a command transmitted from the SM-DP+ 170 to the terminal. The RPM may be requested by a communication provider, a service provider, a terminal owner, and a command may be generated by the SM-DP+ 170.

The communication modem 125 of the terminal 105 refers to a device that modulates and transmits a signal for information delivery and demodulates the signal to restore an original signal at a receiving side. In the case of the MEP support modem, two or more baseband processors (hereinafter, basebands) for wireless communication may be installed. The baseband may be logically implemented in the modem. The modem 125 is currently connected to UICC or eUICC through one physical pin (smartcard interface following the ISO-7816 standard) and operates in such a manner that the modem transmits an Application Protocol Data Unit (APDU) for the command to the eUICC 150 through the corresponding interface and the eUICC 150 responds with a result value. A SIM card (pSIM) occupies one baseband of the modem through one physical pin and one pSIM has one SIM port. The SIM port and the SIM card slot may be interchangeably used, which is defined as “physical and electronic housing provided on a device to accommodate a physical SIM card” in GSMA Technical Specification (TS).37. The MEP support eUICC 150 is physically connected to the MEP support modem 125 through one physical pin as indicated by reference numeral 170, and a profile within the eUICC 150 occupies one baseband within the MEP support modem 125. Each single profile performs communication with a baseband mapped to the eSIM port through one eSIM port. For example, in FIG. 1, profile 1 155 may occupy baseband 1 using eSIM port 1 in an enabled state and profile 2 160 may occupy and use baseband 2 using eSIM port 2 in the enabled state. In this case, in FIG. 1, the pSIM 145 may be inserted, but may be in a state disconnected from a baseband. Meanwhile, the ISD-R 165 refers to an entity within the eUICC that may be selected only by the LPA 115 or the modem 125 and may store or collect, through an internal operation of the eUICC, metadata of the profile or status and configuration information of the profile in the eUICC and may reply when receiving a command from the LPA 115 or the terminal 105. For example, a case of receiving a profile management command, such as GetProfileInfo( ) as an ISD-R selection command APDU or an APDU message may be included. Meanwhile, the LPA 115 refers to software that operates above the terminal framework 120 and some functions of the LPA 115 may be integrated with the terminal framework 120. A message transmitted from the LPA 115 to the eUICC 150 may be finally transmitted to the eUICC 150 through the terminal framework 120 and the modem 125. The eUICC 150 that receives the corresponding message may verifies an ES10x command in the APDU transmitted from the LPA 115 and may perform profile management operation of the eUICC.

Although FIG. 1 illustrates a case in which two profiles, profile 1 and profile 2, are present in the eUICC 150 for clarity of description, it should be noted that, without being limited thereto, more profiles may be present depending on memory capability of the eUICC 150 and two or more profiles may be present in an enabled state. In the eUICC that supports MEP, the profile 1 155 and the profile 2 160 may be simultaneously enabled. In the case of the eUICC that does not support MEP, only one profile between the profile 1 155 and the profile 2 160 may be enabled. The ISD-R 165 generates a new ISD-P (indicating a security domain for hosting of a profile) and stores or collects, in the eUICC, and provides, to the LPA, necessary eUICC data and service (e.g., local profile management, profile information) required for an LPA function as described above.

Meanwhile, although it is not illustrated in the eUICC 150 of the terminal 105 in FIG. 1 for clarity of description, credentials required by security domains of the eUICC may be included, such as, for example, an embedded UICC controlling authority security domain (ECASD) that is a space to store a certificate issuer's root public key for verifying SM-DP+ certificate and a keyset of an eUICC manufacturer, and an eSIM operating platform.

The terminal framework 120 refers to an operating system of the terminal and may be present between the modem and other terminal systems and the general app and the LPA. The terminal framework 120 may acquire and retain (or store) information on the eUICC from the modem 125 and may reply with the corresponding information upon request for information on the terminal or the eUICC from the general app or the LPA. Also, the terminal framework 120 may generate a command APDU in response to a channel open or port open command received from the general app or the LPA, may transmit the same to the modem, may receive a response message to the APDU from the modem, and then may deliver the same to the general app or the LPA. An example of the command APDU generated by the modem in response to the port open command may be a command for explicit port opening and another example thereof may be a port reset command to change a state of an already open port (change from disabled state to enabled state). In the present invention, the meaning of an open port or opening a port is used to refer to a state in which the terminal and the card are initialized to a state in which APDU transmission and reception is possible on the corresponding port. For example, the meaning of opening a port may include entering a use state through a process of selecting or initializing a corresponding port such that the terminal may transmits an APDU in a case in which the port is open between the modem of the terminal and the eUICC, but is in a disabled state and APDU transmission and reception has not occurred on the corresponding port in a card session between the terminal and the card. Meanwhile, when the modem of the terminal does not provide a port for APDU transmission and reception with a specific enabled profile, it is described that the corresponding enabled profile is present in the closed port. The closed port may also include a port that is opened between the modem of the terminal and the eUICC, but is in a disabled state. For example, the profile of the eUICC occupies a baseband included in the modem using a port and the closed port may indicate that the port is in a disabled state.

Also, the terminal framework 120 may receive channel.transmit (command APDU) called from the general app or the LPA and may deliver the same to the general app or the LPA in a channel.transmit (response APDU) format.

As described above, the SM-DP+ server 170 may refer to a server that includes a function of generating a profile, encrypting the generated profile, generating a profile remote management command, or encrypting the profile remote management command or includes a function of supporting multiple profile enabling of the terminal.

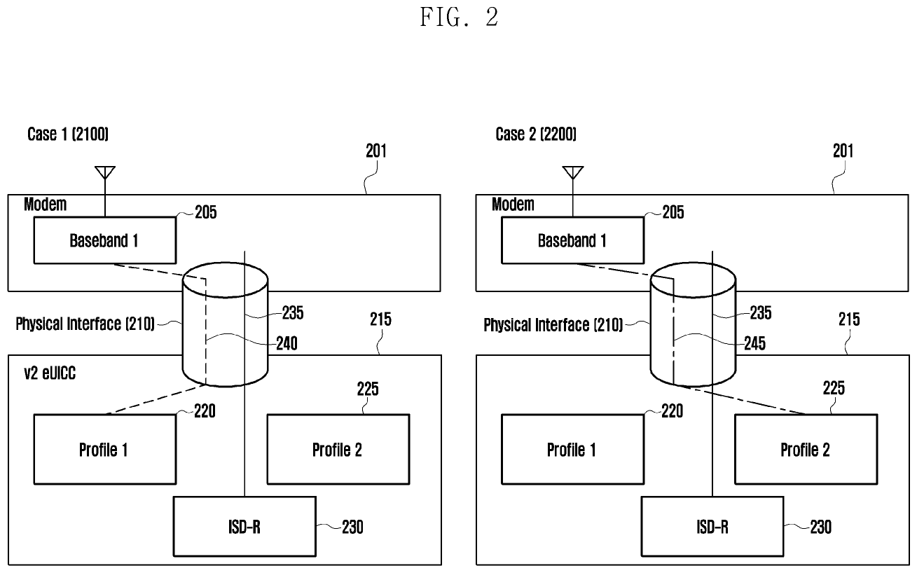

FIG. 2 schematically illustrates an example of connection between a modem and a v2 eUICC not supporting MEP in a wireless communication system according to an embodiment of the disclosure.

In general, in v2 eUICC, only one profile may be enabled in the eUICC and only a user's local profile management is possible without intervention of SM-DP+ to process, such as enable/disable/delete/update of an already installed profile. In the case of a modem 201 that does not support MEP, the modem 201 may have only one baseband in consideration of simultaneously using a physical SIM card and the eUICC. However, in the disclosure, one baseband is assumed for description. In an initialization process between the terminal and the eUICC, the modem 201 may identify the maximum number of openable channels through Answer to Reset (ATR) information received through the eUICC and may generate a maximum of 20 channels (numbered 0 to 19). In an initialization process between the modem and the eUICC, the modem may generate a channel for selecting ISD-R within the eUICC to transmit an APDU through a MANAGE CHANNEL Open Command. Afterwards, when receiving a request for opening a channel from a terminal framework at a specific point in time, the modem may additionally open each independent channel for processing a profile between an application and the eUICC or APDU transmission between an LPA and ISD-R and may transmit the APDU. In general, since only one physical interface is used between the modem and the card, the modem may perform APDU transmission by allocating an independent channel to process APDU transmission to an end between specific applets within a profile between the application and the eUICC in the corresponding interface or between the LPA and the ISD-R.

Only one profile is simultaneously enabled in the eUICC up to v2 eUICC 215. As in Case 1 2100 or Case 2 2200, one enabled profile 220 or 225 occupies one baseband 205 of the modem 201. When an enabled profile of the eUICC 215 needs to transmit a refresh proactive command to the modem 201, the modem 201 may transmit APDU through a channel allocated to an app ID of the corresponding profile. For example, in Case 1 2100, a USIM application of the profile 1 220 may transmit the APDU through an arbitrary channel #0 240 allocated by the modem between the basebands 1 205.

Meanwhile, when ISD-R 230 receives an ES10c.EnableProfile (profile 2) request for a profile state change, for example, state change from Case 1 2100 to Case 2 2200 from the LPA or when the ISD-R 230 receives an eUICC memory reset request, the ISD-R 230 may transmit, to the modem 210, a proactive command that includes UICC reset and/or profile state change (eUICC profile state change) through a REFRESH Proactive Command to delete data of an existing cached profile and/or restart an application session as indicated by reference numeral 235. In this case, the ISD-R 230 may transmit a response APDU indicating presence of the proactive command as a reply value to the APDU transmitted from the modem 201 to the ISD-R 230. The modem 201 may receive the response APDU, may transmit a fetch APDU command through a basic channel, and may return a proactive command to the UICC reset or profile state change (eUICC profile state change) as the body of the response APDU of the corresponding message. If the state change from Case 1 2100 to Case 2 2200 is completed, the USIM application of the profile 2 225 in Case 2 220 may transmit the APDU through an arbitrary channel 245 allocated by the modem between the basebands 1 205.

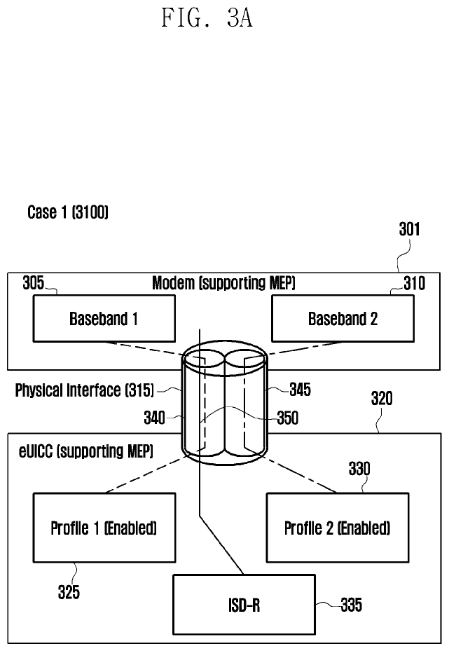

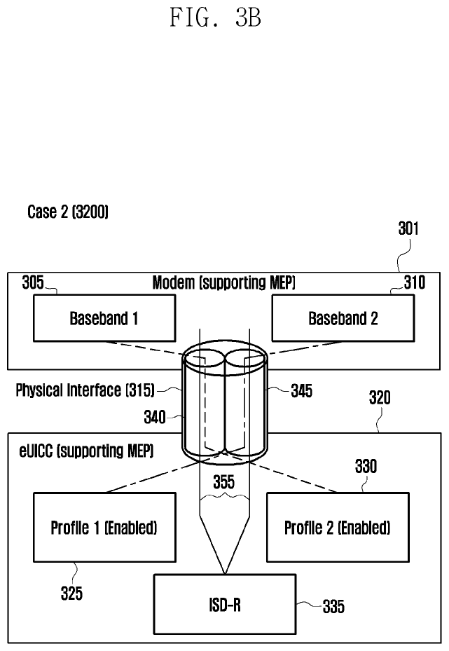

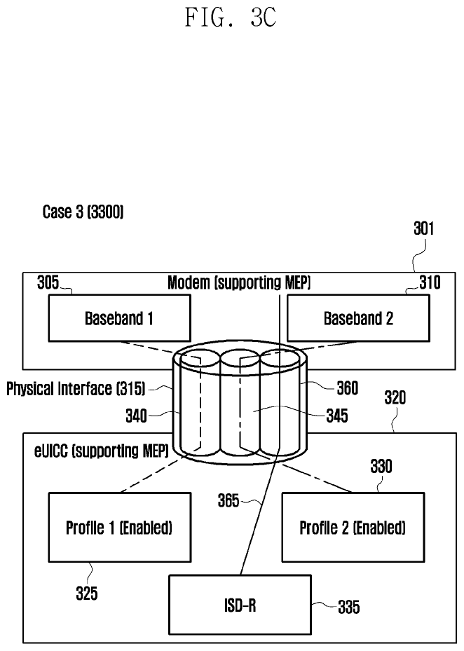

FIGS. 3A to 3C illustrate an ISD-R approach between an eUICC and a modem according to introduction of a virtual interface concept in a wireless communication system according to an embodiment of the disclosure.

In FIGS. 3A to 3C, it is assumed that an eUICC 320 is an eUICC that supports a MEP function capable of simultaneously enabling a plurality of profiles. Meanwhile, a modem 301 is assumed as a modem that supports the MEP function. FIGS. 3A to 3C are described using a situation in which two basebands (baseband 1 305 and baseband 2 310) and two enabled profiles (profile 1 325 and profile 2 330) are present as an example. Mapping between a baseband within the modem 301 and an eSIM port may be switched. However, in Case 1 3100 of FIG. 3A to Case 3 3300 of FIG. 3C, for clarity of description, mapping of logical terminal endpoints within the modem 301 is described by limiting to between the baseband 1 305 and channel 1 340 and between the baseband 2 310 and channel 2 345.

The eUICC 320 that supports MEP may enable a plurality of profiles, and each enabled profile may occupy and use a specific baseband of the modem. Since two or more profiles are simultaneously enabled in MEP, the existing logical interface concept of transmitting APDU by multiplexing a physical interface 315 for each enabled profile may be introduced. Hereinafter, for clarity of description, the corresponding logical interface is referred to as an eSIM port and divided into eSIM port #1 340, eSIM port #2 345, and eSIM port #0 360 for description.

As a result of terminal-card initialization, a port for APDU transmission between the modem and the eUICC and a transmission channel within the port may be generated. Here, an eSIM port ID mapped to each baseband may be configured. The corresponding port ID may be configured by the modem or a terminal platform and delivered to an LPA. In the disclosure, the port ID is interchangeably used with a port number for clarity of description. The modem may open the greater number of eSIM ports than the number of basebands. The number of eSIM ports used in the eUICC 320 may be equal to or less than the number of profiles that may be simultaneously enabled in the corresponding eUICC. The profile may perform APDU message transmission and reception with the terminal using one of the corresponding eSIM ports and may transmit a proactive command to the modem.

In examples of FIGS. 3A to 3C, the modem 301 may transmit an APDU command to the enabled profile 1 325 through the eSIM port #1 340. The profile 1 325 may transmit a related proactive command that affects the baseband 1 305 through the eSIM port #1 340. The modem 301 may transmit an APDU command to the enabled profile 2 330 through the eSIM port #2 345. The profile 2 330 may transmit a related proactive command that affects the baseband 2 310 through the eSIM port #2 345.

Meanwhile, as in Case 1 3100 of FIG. 3A, Case 2 3200 of FIG. 3B, or Case 3 3300 of FIG. 3C, as described below, the terminal (e.g., LPA or modem of terminal) may configure an eSIM port used to transmit APDU to an ISD-R 335 with one of the following three cases. Although the LPA is not illustrated in FIGS. 3A to 3C, a message may be transmitted to the modem through the terminal framework or to the ISD-R 335 of the eUICC through the modem as described above with FIG. 1.
Case1 3100 of FIG. 3A: The ISD-R 335 is selected only through one of eSIM ports (hereinafter, Case 1 of FIG. 3A is described as dedicated port or MEP-B′ method). The eSIM port used by the ISD-R 335 shares a port with the profile, but uses an independent single channel within the port. In this case, for example, the LPA or the modem performs APDU transmission and reception with the ISD-R 335 only through a channel 350 allocated to the ISD-R 335 within the port #1 340.
Case 2 3200 of FIG. 3B: The ISD-R 335 is selected through any eSIM port occupied by the profile (hereinafter, Case 2 of FIG. 3B is described as any port or MEP-B method). The eSIM port used by the ISD-R 335 may share a port with a profile that occupies the corresponding port, but may use an independent single channel within the port. In this case, for example, the LPA or the modem of the terminal selects one of a channel 355-1 allocated to the ISD-R 335 within the port #1 340 and a channel 355-2 allocated to the ISD-R 335 within the port #2 345 and simultaneously or asynchronously performs APDU transmission and reception with the ISD-R 335.
Case 3 3300 of FIG. 3C: The ISD-R 335 is selected through an ISD-R exclusive port and does not share a port with a profile that occupies the corresponding port (hereinafter, Case 3 of FIG. 3C is described with exclusive port or MEP-A method). Meanwhile, the MEP-A method may be classified into a MEP-A1 method when the LPA determines a port to enable a profile and informs the eUICC, or may also be additionally classified into a MEP-A2 method when the eUICC determines a port to enable a profile.

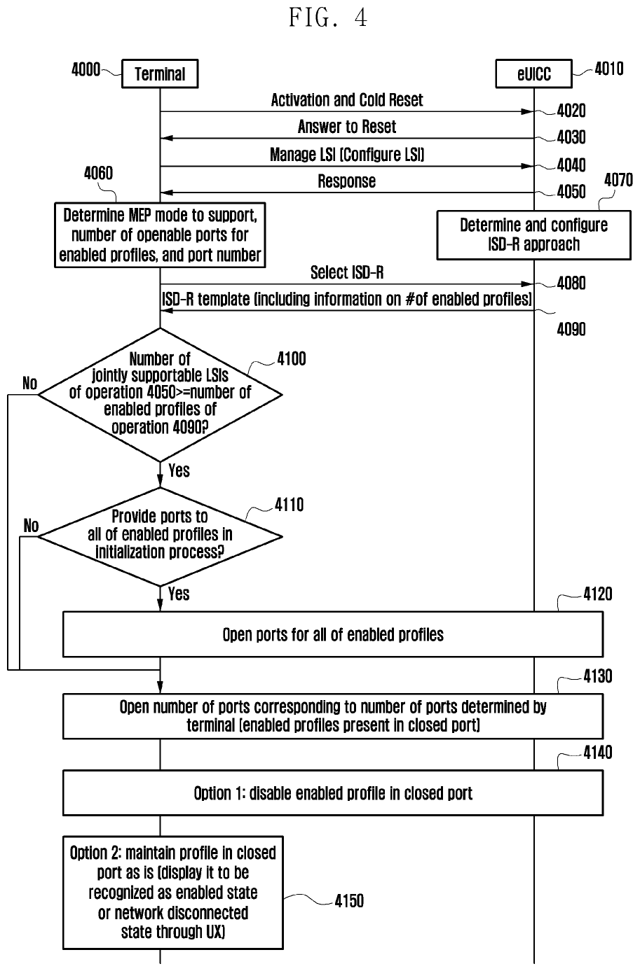

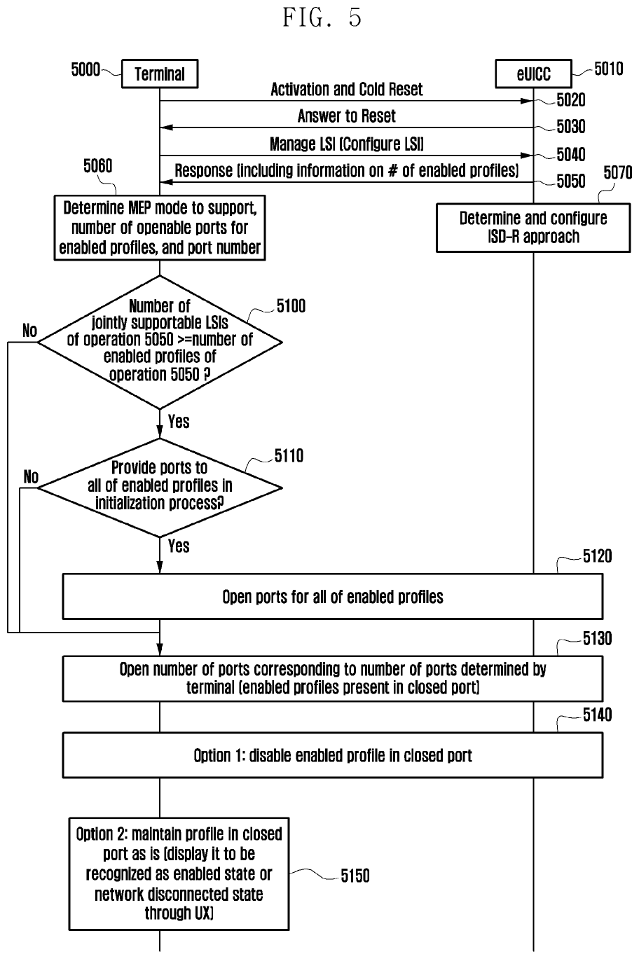

A case expressed as an ISD-R selection method in the drawings below may be explained by including determining an entity to determine a port to enable. For example, when determining the ISD-R selection method or determining a mode in FIGS. 4 and 5, it is explained with terms that include the entity to determine a port to enable, such as MEP-A1 and MEP-A2. The dedicated port is present independently of the eSIM port used by the profile and uses a single channel within the corresponding port. In this case, for example, the modem or the LPA needs to perform APDU transmission and reception with the ISD-R 335 using a channel 365 allocated within the independent ISD-R dedicated port and the eUICC needs to return an error to the LPA for a profile management command message received on a port other than the ISD-R dedicated port.

With which ISD-R approach a terminal selects to perform APDU transmission and reception with an ISD-R may be determined in a terminal-eUICC initialization process and may be received by an LPA through a terminal framework, which is described below in FIG. 5. Decision in the terminal-eUICC initialization process may be made through performance negotiation between the terminal and the card, or may be configured by the eUICC in such a manner that the terminal (e.g., LPA of the terminal) makes a decision and informs the eUICC, or may be configured by the terminal in such a manner that the eUICC informs the terminal. Alternatively, without making a decision during the initialization process, the LPA may also determine the ISD-R approach in a manner that is predefined for use in the terminal, which may be a pre-configured method determined by a terminal manufacturer-eUICC manufacturer when manufacturing the terminal. Alternatively, even without knowing the method determined by the terminal, the eUICC may be implemented such that it may be processed by the eUICC.

FIG. 4 illustrates an operation of determining a handling method for the number of ports to be used for an enabled profile in a terminal and an enabled profile in a closed port with reference to information on the number of supportable ports and enabled profiles collected from an eUICC during a terminal-card initialization process according to an embodiment of the disclosure.

In general, a terminal-card initialization procedure is as follows. When an eUICC 4010 inserts into a terminal 4000, a modem (not shown) of the terminal 4000 may perform Activation and Cold Reset (operation 4020) of recognizing a corresponding card and configuring an operating environment for operation with an eUICC card, such as power supply, clock synchronization, current, and voltage, to use the corresponding card. According to an embodiment of the disclosure, the terminal 4000 of FIG. 4 may refer to the modem or an LPA included in the terminal 4000. When operating environment configuration for using the corresponding card is completed, the eUICC 4010 may transmit an Answer to Reset (ATR) message to the modem (not shown) of the terminal 4000 (operation 4030). The ATR message refers to a message that is first transmitted from the card to the terminal and message blocks configured with up to 32 bytes may be transmitted in a continuous chain. The eUICC 4010 may include information as to whether eUICC functionality defined in GSMA SGP.22 is supported in one of message blocks defined with an interface byte among the message blocks of the ATR message and may transmit the same to the modem (not shown) of the terminal 4000. Also, when the card supports a logical interface, the card may indicate logical interface support with ATR and may transmit the same to the modem (not shown) of the terminal 4000.

Meanwhile, with the corresponding ATR message (operation 4030), the eUICC 4010 may reply with information such as a supported transport protocol and whether the transport protocol is changeable. The modem (not shown) of the terminal 4000 may determine to use the transport protocol supported by the card as is or when ATR includes an identifier for transport protocol changeability, may additionally transmit a request for determining a transport protocol and parameter to the eUICC 4010 and the terminal 4000 may make a final decision (4030) through a process of negotiating a transport protocol to be used between the terminal 4000 and the eUICC 4010. Here, the terminal and the card may transmit an APDU message using either T=0 or T=1 that is a transport protocol defined in ISO 7816-3. The APDU refers to a data unit that includes a pair of command-response and may be used in an application for message processing between other applications.

When the ATR message is received (operation 4030), a card session is generated between the terminal 4000 and the eUICC 4010 and, from this point in time, APDU transmission and reception may be performed between the modem of the terminal 4000 and the eUICC 4010.

After a card session is established between the terminal modem and the eUICC, APDU transmission and reception may be performed between the terminal modem and the eUICC and thus, the modem may transmit SELECT Master File and Terminal Capability Command to the eUICC 4010 in the initialization process at a specific point in time. Before transmitting the SELECT Master File and the Terminal Capability Command, the terminal 4000 may transmit a message for acquiring LSI configuration information to the eUICC 4010 with an LSI management command. Also, in a case in which the terminal 4000 acquires information indicating the card that supports LSI with information received through the ATR (operation 4030) at a point in time before transmitting the corresponding SELECT Master File, if the terminal 4000 supports the LSI, the terminal 4000 may transmit the APDU command such as corresponding Manage LSI (configuration information of terminal on Instruction=Configure LSI, DATA=LSI). In the case of supporting eUICC functionality through the previously received ATR message (operation 4030), the terminal 4000 may transmit the same by including information for MEP support of GSMA in corresponding data. ETSI defines an interface between the modem (not shown) of the terminal 4000 and the card, and a physical interference may be referred to as LSI. The card may be an eUICC, a UICC, or an eSE card. For example, in SGP.21/22 of GSMA, a logical interface defined for MEP support refers to an eSIM port and it should be noted that the eSIM port is LSI, but LSI defined in the ETSI is the larger concept of including the eSIM port. Therefore, DATA of Manage LSI (configuration information of terminal on Instruction=Configure LSI, DATA=LSI) transmitted in operation 4040 may include MEP information defined in SGP.21/22 of GSMA and thereby be transmitted. Also, the DATA field transmitted in operation 4040 may also be transmitted along with information on which method the terminal supports among the ISD-R approaches presented in FIG. 3. For example, the DATA field may be in a format as shown in Table 1 below. Meanwhile, the number of openable ports for enabled profiles between the terminal and the card may vary depending on an ISD-R selection method. For example, in a case in which that the terminal 4000 supports MEP-A1 and MEP-B is transmitted and LSI=3 is transmitted, when operating as MEP-A1, the maximum number of ports that the terminal may open for enabled profiles between the terminal and the card may be 4 (including port for ISD-R) and the maximum number of openable ports for MEP-B may be 3 based on Table 1 below.

TABLE 1

| Byte(s) | Description | Value | Length |
|---|---|---|---|
| 1 | Tag for MEP mode(s) of the Device | ′90′ | 1 |
| 2 | Length of next field | N | 1 |
| 3 to N + 2 | MEP mode(s) supported by the Device in the | — | N = |
| | order of priority | | 1 to 4 |
| | ′01′: MEP-A1 | | |
| | ′02′: MEP-A2 | | |
| | ′03′: MEP-B | | |
| | ′04′: MEP-B′ | | |
| N + 3 | Tag for maximum number of LSIs for | ′91′ | 1 |
| | Enabled Profiles of the Device | | |
| N + 4 | Length of next field | 1 | 1 |
| N + 5 | Maximum number of LSIs supported for | — | 1 |
| | Enabled Profiles | | |

Meanwhile, in response thereto, the eUICC 4010 may reply to the terminal 4000 including the number of jointly supportable LSIs as a response to the message received in operation 4040, in the Response Data Field of the Manage LSI (Configure LSI) (operation 4050). In operation 4050, the eUICC 4010 may also reply with indication of a jointly supportable ISD-R selection method. Table 2 below shows information included in a response message with which the eUICC 4010 replies to the terminal 4000 according to an embodiment of the disclosure.

TABLE 2

| Byte(s) | Description | Value | Length |
|---|---|---|---|
| 1 | Tag for MEP modes | ′90′ | 1 |
| 2 | Length of next field | 1 + M | 1 |
| 3 | Jointly supported MEP mode, coding see table | — | 1 |
| | above | | |
| | Set to ′00′ in case of no jointly supported | | |
| | MEP mode. | | |
| 4 to M + 3 | All MEP modes supported by the UICC (including | — | M |
| | the mode given in byte 3 in arbitrary | | |
| | order, coding see table above | | |
| M + 4 | Tag for jointly supported maximum number of | ′91′ | 1 |
| | LSIs for Enabled Profiles | | |
| M + 5 | Length of next field | 1 | 1 |
| M + 6 | Maximum number of LSIs jointly supported for | — | 1 |
| | Enabled Profiles | | |

The terminal 4000 that receives the response message may identify the number of openable ports for enabled profiles between the terminal and the card and may also identify a jointly supportable MEP mode. If absence of a jointly supportable mode is received, the terminal may be processed to operate in a SEP mode and then may be terminated without performing an additional operation for MEP mode initialization (operation 4060). At a later point in time, the terminal 4000 may designate a number of a port to be opened and may transmit a command to open the port to the eUICC 4100. The port to be opened may be designated with sequential number, such as 0, 1, and 2, or may be arbitrarily designated by the terminal 4000 and the terminal 400 may include a command to open the port and may provide the same to the eUICC 4100. The eUICC 4010 may receive the message of operation 4040 to identify the ISD-R approach preferred by the terminal 4000 and to identify the jointly supportable ISD-R approach (e.g., MEP mode to support). The eUICC 4010 may determine a support method with the jointly supportable approach in order preferred by the terminal and may process configuration in the corresponding mode. For example, when configured as MEP-A1, the eUICC 4010 may provide configuration for MEP-AI support, such as processing a profile enable message to be recognized as being received including a port number and configuring ISD-R to be accessible only through port No. 0 (operation 4070). Alternatively, when the eUICC 4010 determines that there is no ISD-R approach jointly supportable with the terminal in operation 4070, the eUICC 4010 may notify that there is no jointly supportable method and may be configured to operate in a SEP support mode rather than MEP in operation 4070. The above operation may be performed after receiving the method of operation 4040 and before transmitting the response of operation 4050. Meanwhile, the modem (not shown) of the terminal 4000 may determine the number of ports to be opened and port number and then may immediately determine to open a port, may transmit a command to open the port or may additionally receive reply of information from the eUICC 4100 through ISD-R selection (operation 4080) and then process the same.

The modem (not shown) of the terminal 4000 may transmit an APDU command to select ISD-R in order to receive additional information on the eUICC 4010 during the initialization process and may select the ISD-R (operation 4080). If the terminal 4000 selects the ISD-R, the ISD-R is ISDR Proprietary ApplicationTemplate as a reply value thereto and the eUICC 4010 may provide ISD-R template information to the terminal 4000 (operation 4090).

As a corresponding selection result, the eUICC 4010 may transmit information replied in operation 4090, including the number of enabled profiles and/or a number of a port allocated to an enabled profile. Without being limited to an example below, an example of an indication method may include a form as shown Table 3 below (example of providing the number of enabled profiles and port number together)

```
TABLE 3
ISDRProprietaryApplicationTemplate ::= [PRIVATE 0] SEQUENCE { -- Tag ‘E0’
lowestSvn [2] VersionType,
euiccConfiguration BIT STRING {
  1paeUsingCatSupported(0), -- LPA in the eUICC using Card Application Toolkit
  1pacUsingSewsSupported(1), -- LPA in the eUICC using Smartcard Web Server
  enabledProfile(2), -- eUICC contains an Enabled Profile
  1paeUsingE4ESupported(3), -- LPA in the eUICC using ‘E4’ ENVELOPEs
  isdrIsMepSelectable(4) -- #SupportedForMEPv3.0.0# the ISD-R can be selected on a
ny open eSIM Port
} OPTIONAL,-- #MandatoryFromV3.0.0#
listEnabledProfiles SEQUENCE (SIZE(1..16)) OF INTEGER (0..15) OPTIONAL --
  #SupportedForMEPV3.0.0# the eSIM Port associated with an Enabled Profile is liste
d in ascending order
}
```

Alternatively, an example of the indication method may include a form as shown in Table 4 below (example of providing only the number of enabled profiles).

```
TABLE 4
ISDRProprietaryApplicationTemplate ::= [PRIVATE 0] SEQUENCE { -- Tag ‘E0’
lowestSvn [2] VersionType,
euiccConfiguration BIT STRING {
  1paeUsingCatSupported(0), -- LPA in the eUICC using Card Application Toolkit
  1paeUsingSewsSupported(1), -- LPA in the eUICC using Smartcard Web Server
  enabledProfile(2), -- eUICC contains an Enabled Profile
  1pacUsingE4ESupported(3), -- LPA in the eUICC using ‘E4’ ENVELOPEs
  isdrIsMepSelectable(4) -- #SupportedForMEPv3.0.0# the ISD-R can be selected on a
ny open eSIM Port
} OPTIONAL,-- #MandatoryFromV3.0.0#
numOfEnabledProfiles INTEGER (0..15) OPTIONAL -- #SupportedForMEPV3.0.0#
  the number of currently Enabled Profiles}
```

The terminal 4000 may determine the quantity to be opened for enabled profiles (operation 4100). For example, the terminal 4000 may determine the number of ports that need to be opened. Depending on configuration and decision of the terminal 4000, a case of opening all of or none of ports may occur in the initialization process (operation 4110). The case in which the terminal 4000 opens all of the ports may be a case in which the terminal 4000 determines to provide all ports to enabled profiles in terminal configuration. The case in which the terminal 4000 does not open or determines to not open all of the ports may be, for example, a case in which the number of basebands providable from the terminal 4000 is 2. The terminal 4000 may operate in a MEP-B mode with reference to information of operation 4040. Also, the above case may be a case in which the maximum number of LSIs jointly providable to the enabled profiles is 2 with reference to operation 4040 but the number of enabled profiles replied in operation 4090 is 3. Alternatively, the above case may be a case in which the terminal 4000 designates the number of LSIs as the maximum number defined in ETSI, for example, the eUICC 4010 is notified that the terminal 4000 supports 15 (operation 4040) and the eUICC 4010 replies with 15 (operation 4050), but the number of enabled profiles is 16.

In a case in which the terminal 4000 is capable of opening all of the number of enabled profiles or the agreed number of LSIs greater than the number of enabled profiles in consideration of the enabled profiles, if an enabled profile is not supported in a closed port, the terminal 4000 may process at least the same number of ports as the number of enabled profiles to be available. This may be, for example, one of a command to transmit a Manage LSI (Reset) command to the eUICC, (which is performed twice if two need to be opened) or to explicitly open a port, or an arbitrary APDU command indicating that the terminal enables and uses a corresponding port on a new port. The initialization process may be completed in such a manner that the eUICC 4010 processes all of enabled profiles to be allocated with ports (operation 4120). In this case, the terminal 4000 may process user experience (UX) such that the LPA may recognize a profile enabled state as a network accessible state at all times. Meanwhile, as an example of entry into operation 4120, when the terminal 4000 desires to change an enabled profile with a physical SIM card and use the same in the eUICC 4010 to disallow the enabled profile in a closed port, the terminal 4000 may be configured to perform an operation of initially disabling a state of the enabled profile in an open port in MEP based on GSMA SGP.22 and then to perform an operation of processing a change to the physical SIM card. Alternatively, although not configured that way, the terminal 4000 may be configured to maintain and open the number of LSIs equal to the number of LSIs used in a previous card session at all times at a specific point in time after performing operation 4030 when performing the initialization procedure between the terminal 4000 and the eUICC 4100 (including rebooting). In this case, the terminal 4000 may enter operation 4120 according to decision in operations 4100 and 4110 of FIG. 4 and thus, may open ports for all of the enabled profiles such that there is no enabled profile in the closed port. This may be applied equally between a terminal 5000 and an eUICC 5100 of FIG. 5 as a method for entering operation 5120 of FIG. 5, described below.

Meanwhile, when the terminal 4000 is incapable of providing all ports for enabled profiles or when the terminal 4000 is capable of providing all ports but does not desire to provide ports for all the enabled profiles, the terminal 4000 may open the number of ports determined by the terminal 4000 in operation 4110. Therefore, a profile enabled state may be present in the closed port (operation 4130). In this case, the terminal 4000 may identify whether state change processing of disabling the enabled profile is required as in operation 4140 as a method of determining processing of the enabled profile in the closed port. Operation 4140 may be subdivided and processed as follows. If the terminal 4000 is configured to disallow an enabled state of a profile present in the closed port, the terminal 4000 may display a screen indicating that the LPA of the terminal 4000 needs to perform profile disable processing such that the user may enter profile disable processing and may notify that disable processing needs to be performed to force the user to perform a profile disable operation. If the terminal 4000 is configured to allow the enabled state of the profile present in the closed port, the terminal 4000 may additionally display a screen requesting the user to perform disable processing of the enabled profile on the corresponding closed port, inducing the user to enter profile disable processing.

When the user selects to disable the enabled profile in the closed port in operation 4140, the terminal 4000 may transmit a processing command to disable the corresponding profile through an open ISD-R dedicated port if operating with MEP-A, or through one of open ports if operating with MEP-B. If the user does not select to disable the profile in operation 4140, the LPA of the terminal 4000 may maintain the profile in the closed port and may combine a baseband connection state received from the terminal framework and profile state information acquired from the eUICC 4010 to configure an enabled state or a network disconnection state to be recognized by the user and may display or indicate the same on a user screen as in operation 4150.

Next, a procedure of performing, by the terminal 4000 and the eUICC 4100, profile disable processing in operation 4140 is described in detail. The procedure of performing, by the terminal 4000 and the eUICC 4100, profile disable processing may be processed during a process of performing, by the terminal 4000 and the eUICC 4100, initialization in operation 4140. Alternatively, in a case in which the terminal 4000 and the eUICC 4010 complete the initialization process by immediate entry into option 2 (operation 4150), the procedure may be performed between the terminal 4000 and the eUICC 4100 when the user desires to perform profile disable processing by entering a menu for profile management of the LPA at a specific point in time after the initialization process.

By transmitting information acquired by the modem of the terminal 4000 from the terminal 4000 to the LPA through the terminal framework, the LPA may additionally generate a message indicating that the user needs to perform disable processing of a corresponding profile and may transmit ES10c.DisableProfile (ID of enabled profile in closed port) for disable processing of the corresponding profile to the eUICC 4010 according to user or user consent-based terminal configuration. An operation in which the eUICC 4010 that receives the same changes state information of the profile to a disabled state based on the corresponding information and replies to the LPA that disable processing is completed is described. In a case in which an ID for RefreshFlag is added to ES10c.DisableProfile (ID of enabled profile in closed port, RefreshFlag) and thereby transmitted, the eUICC 4010 may not transmit a REFRESH Proactive Command to the modem if the corresponding profile is present in the closed port. When the profile is present in an open port, the eUICC 4010 needs to transmit the REFRESH Proactive Command for profile state change to the modem. If processing fails, the eUICC 4010 needs to return an error to the LPA. However, when the eUICC 4010 determines that the profile is present in the closed port and, here, the eUICC 4010 receives RefreshFlag but is incapable of processing the same, the eUICC 4010 may complete processing by replying to the LPA as a normal response that processing is performed, without returning the error to the LPA. When transmitting the ES10c.DisableProfile (ID of enabled profile in closed port) to the eUICC 4010, the LPA of the terminal 4000 may transmit a command to a port to perform enable or disable processing when a mode in which the terminal and the eUICC agree to operate during the initialization process, (which may be determined in operations 4040 and 4050 or may be determined as a pre-agreed mode if operation 4040 or 4050 is not used) is a MEP-B mode. However, the LPA may detect that the corresponding port is closed through information acquired through the terminal framework and may additionally recognize that the terminal 4000 may open the port. Therefore, the LPA does not transmit a request command to open the port to the modem and the LPA may select one of open ports at a corresponding point in time and may transmit the command to the eUICC 4010.

The eUICC 4010 operating in MEP-B that receives the command may return an error since it is not a command for an enabled profile on a port, but may detect that the command is a command for a profile present on another (closed) port and may process the command without returning the error. Also, in this case, it should be noted that a corresponding disable command needs to be processed based on an ID of a profile included in ES10c.DisableProfile (ID of enabled profile in closed port) without processing a profile command based on port information for which the command is received. When the eUICC 4010 is configured to not process the received command for the enabled profile on the port, the eUICC 4010 may complete the procedure by returning the error to the LPA as a response to the corresponding disable command received through the LPA.

The modem (not shown) of the terminal 4000 that receives information from the eUICC 4100 delivers the information acquired from the eUICC 4100 to the framework (not shown) of the terminal 4000 to be used in an application of the terminal or a system. The modem (not shown) of the terminal 4000 may complete the initialization process by sequentially providing or combining information acquired at a specific point in time after a point in time at which the information is acquired from the eUICC 4010 and providing the same to be used in the application of the terminal or the system. Meanwhile, although it is not illustrated in the drawings, the terminal 4000 and the eUICC 4010 may use pre-agreed configuration. In this case, the negotiation procedure of operations 4040 and 4050 may be skipped. Alternatively/additionally, in operation 4090, information may be received without including enabled profile information. In this case, the terminal 4000 may proceed with operation 4060 using a preconfigured MEP mode to support, the number of openable ports for enabled profiles, and port number. The eUICC 4010 may proceed with operation 4070 by determining and having configuration as ISD-R approach with preconfigured information (number of openable ports for enabled profiles and port number are preconfigured in the eUICC 4010). Also, when the terminal 4000 and the eUICC 4010 are additionally configured to not support the enabled profile in the closed port, and here when the terminal 4000 desires to change the enabled profile with a physical SIM card and use the same in the eUICC 4010, the terminal 4000 may be configured to perform an operation of initially disabling a state of the enabled profile in an open port in MEP based on GSMA SGP.22 and then to perform an operation of processing a change to the physical SIM card. Alternatively, although not configured that way, the terminal 4000 may be configured to maintain and open the number of LSIs equal to the number of LSIs used in a previous card session at all times at a specific point after performing operation 4030 when performing the initialization procedure between the terminal 4000 and the eUICC 4100 (including rebooting). In this manner, the terminal 4000 may open ports for all of enabled profiles such that there is no enabled profile in the closed port as in operation 4120, or may not perform that way (operation 4130).

If the number of ports to be mutually used by the terminal 4000 and the eUICC 4010 and port numbers are preconfigured, the terminal 4000 and the eUICC 4010 may open all pre-agreed ports after performing operation 4030, for example, leave the ports in an available state to not perform a procedure of opening ports individually. According to an embodiment, it may indicate that, without performing an operation of transmitting Manage LSI (reset) APDU for each port to be used in a state in which APDU transmission and reception is possible on a corresponding port and receiving ATR as a response thereto on the corresponding port, the terminal 4000 and the eUICC 4100 enter the corresponding state to perform preparation. Description of applying a pre-agree method is described with reference to FIG. 4, but it may be equally applied to FIGS. 5 to 7 and FIG. 8.

FIG. 5 illustrates an operation of determining a handling method for the number of ports to be used for an enabled profile in a terminal and an enabled profile in a closed port with reference to information on the number of supportable ports and enabled profiles collected from an eUICC during a terminal-card initialization process according to another embodiment of the disclosure.

It should be noted that the repeated description made above with FIG. 4 may be omitted in FIG. 5 and a part not further described in FIG. 5 may also be performed with reference to the description made above in FIG. 4.

As described above in detail with reference to FIG. 4, while performing the terminal-card initialization procedure, DATA of Manage LSI (configuration information of terminal on Instruction=Configure LSI, DATA=LSI) may be included in MEP information defined in SGP.21/22 of GSMA and transmitted. Operations 5020 to 5040 of FIG. 5 may be described in the same manner as operations 4020 to 4040 of FIG. 4 and thus description related thereto is omitted.

The DATA field transmitted in operation 5040 may also be transmitted along with information on which method the terminal supports among the ISD-R approaches presented in FIG. 3. According to an embodiment, the DATA field may be in a format as shown in Table 5 below. Meanwhile, the number of openable ports for enabled profiles between the terminal and the card may vary depending on an ISD-R selection method. For example, in a case in which that the terminal 5000 supports MEP-A1 and MEP-B is transmitted and the number of LSIs openable for enabled profiles=3 is transmitted in an example of Table 5 below, when operating as MEP-A1, the maximum number of ports that the terminal may open may be 4 (including port for ISD-R) and the maximum number of openable ports for MEP-B may be 3.

TABLE 5

| Byte(s) | Description | Value | Length |
|---|---|---|---|
| 1 | Tag for MEP mode(s) of the Device | ′90′ | 1 |
| 2 | Length of next field | N | 1 |
| 3 to N + 2 | MEP mode(s) supported by the Device in the | — | N = |
| | order of priority | | 1 to 4 |
| | ′01′: MEP-A1 | | |
| | ′02′: MEP-A2 | | |
| | ′03′: MEP-B | | |
| | ′04′: MEP-B′ | | |
| N + 3 | Tag for maximum number of LSIs for | ′91′ | 1 |
| | Enabled Profiles of the Device | | |
| N + 4 | Length of next field | 1 | 1 |
| N + 5 | Maximum number of LSIs supported for | — | 1 |
| | Enabled Profiles | | |

Meanwhile, the eUICC 5010 may reply to the terminal 5000, including the number of jointly supportable LSIs as a response to the message received in operation 5040, in the Response Data Field of the Manage LSI (Configure LSI). The eUICC 5010 may reply to the terminal 5000 with indication of a jointly supportable ISD-R selection method. Additionally, if an enabled profile is currently present, the eUICC 5010 may reply including the number of enabled profiles or/and a list of port number(s) that the enabled profiles have. According to an embodiment, a response message of the eUICC 5010 may include a format as shown in Table 6 below.

TABLE 6

| Byte(s) | Description | Value | Length |
|---|---|---|---|
| 1 | Tag for MEP modes | ′90′ | 1 |
| 2 | Length of next field | 1 + M | 1 |
| 3 | Jointly supported MEP mode, coding see | - | |
| | table above | | |
| | Set to ′00′ in case of no jointly supported | | |
| | MEP mode. | | |
| 4 to M + 3 | All MEP modes supported by the UICC (including | — | M |
| | the mode given in byte 3 in arbitrary | | |
| | order, coding see table above | | |
| M + 4 | Tag for jointly supported maximum number | ′91′ | 1 |
| | of LSIs for Enabled Profiles | | |
| M + 5 | Length of next field | 2 + X | 1 |
| M + 6 | Maximum number of LSIs jointly supported | — | 1 |
| | for Enabled Profiles | | |
| M + 7 | Number of currently Enabled Profiles | — | 1 |
| M + 8 | Port number in ascending order associated to | | X = the Value |
| to M + X | the Enabled Profiles indicated in the M + 7 | | of M + 7 |

The terminal 5000 that receives the response message may identify the number of openable ports for enabled profiles between the terminal and the card and may also identify a jointly supportable MEP mode as described above with reference to FIG. 4. If there is no jointly supportable mode, the terminal 5000 may be processed to operate in a SEP mode and then may be terminated without performing a subsequent operation (operation 5060). Meanwhile, the eUICC 5010 may receive the message of operation 5040 to identify the ISD-R approach preferred by the terminal and to identify the jointly supportable ISD-R approach (e.g., MEP mode to support). The eUICC 5010 may determine a support method with the jointly supportable approach in order preferred by the terminal and may process configuration in the corresponding mode. For example, when configured as MEP-A1, the eUICC 5010 may provide configuration for MEP-AI support, such as processing a profile enable message to be recognized as being received including a port number and configuring ISD-R to be accessible only through port No. 0 (operation 5070). Operation 5070 may be performed after receiving the method of operation 5040 and before transmitting the response of operation 5050. At a subsequent point in time, the terminal 5000 may designate a number of a port to be opened and may transmit a command to open the port to the eUICC 5100. As described above with FIG. 1, the command to open the port may include a command to change an APDU to be in a transmission and reception possible state on the open port, which may be equally applied in the present invention. The port to be opened may be designated with sequential number such as 0, 1, and 2, or may be arbitrarily designated by the terminal 5000 and the terminal 5000 may include the command to open the port and may provide the same to the eUICC 5100. Meanwhile, a modem (not shown) of the terminal 5000 may determine the number of ports to be opened and port number(s) and then may immediately process the port to be opened.

Meanwhile, although not described in detail with FIG. 4, when the eUICC 5010 provides port numbers of enabled profiles in FIGS. 4 and 5, the terminal 5000 may sequentially open ports in descending order of port numbers (e.g., 0 1 2 3 4). Alternatively, the terminal 5000 may refer to additional information received from the eUICC 5010 to initially process connection (e.g., profile for enterprise) and may sequentially open ports in descending order of port numbers (e.g., 0 5 1 3 7).

If the eUICC 5010 provides only the number of profiles without providing enabled port numbers, the terminal 5000 may sequentially open ports in descending order of port numbers (e.g., 0 1 2 3 4). Alternatively, if previous connection information is present, the terminal 5000 may refer to the corresponding information and may sequentially open ports (e.g., 0 1 2 3 4). The eUICC 5010 may also reallocate a port number configured in an existing enabled profile according to a received port number (e.g., when the terminal receives 0 1 2 3 and the existing eUICC has 0 3 5 7 9, reallocatement is performed with 0 1 2 3 and a profile unallocated with a port is maintained as 9).

In a case in which the terminal 5000 additionally verifies profile enabling information received in operation 5050 and corresponding information is present, if the terminal 5000 determines that the maximum number of LSIs jointly supported for enabled profiles is equal to or greater than the number of currently enabled profiles (operation 5100) and if the terminal 5000 determines to provide ports for all enabled profiles during the initialization process (operation 5110), the terminal 5000 may process at least the same number of ports as the number of currently enabled profiles to be available. According to an embodiment, this may be one of a command for the terminal 5000 to repeatedly transmit a Manage LSI (Reset) command as many times as necessary to open a port, for example, performing twice if two need to be opened, a command to explicitly open a port, or an arbitrary APDU command indicating that the terminal enables and uses a corresponding port on a new port. The initialization process may be completed in such a manner that the eUICC processes all of enabled profiles to be allocated with ports (operation 5120). In this case, the terminal 5000 may process UX such that the LPA may recognize a profile enabled state as a network accessible state at all times.

Meanwhile, in a case in which the terminal 5000 additionally verifies profile enabling information received through operation 5050 and corresponding information is present, if the maximum number of LSIs jointly supported for enabled profiles is less than the number of currently enabled profiles as a decision result of operation 5100, the terminal 5000 may determine to open the number of ports determined by the terminal 5000 (e.g., the number of LSIs jointly supported for enabled profiles or less) and to maintain the profile enabled state in the closed port (operation 5130). For example, the terminal 5000 may not open an additional port or may determine to not open a port depending on a terminal state. For example, if the number of basebands providable from the terminal 5000 is 2, the terminal 5000 may determine to operate in a MEP-B mode with reference to operation 5050 received from the eUICC 5010. Also, the above case may be a case in which the maximum number of LSIs providable for enabled profiles is 2 with reference to operation 5050 but the number of enabled profiles replied in operation 5050 is 3. Alternatively, the above case may be a case in which the terminal 5000 designates the number of LSIs as the maximum number defined in ETSI, for example, the eUICC 5010 is notified that the terminal 5000 supports 15 in operation 5040 described above and the eUICC 5010 replies with 15 in operation 5050 described above, but the number of enabled profiles is 16.

In the corresponding case, when a command to open the number of ports determined by the terminal 5000 is transmitted, a profile remaining in an enabled state in a closed port may be present among enabled profiles (operation 5130).

Meanwhile, when the terminal 5000 is incapable of providing all ports for enabled profiles or when the terminal 5000 is capable of providing all ports but does not desire to provide ports for all the enabled profiles, the terminal 5000 may identify whether there is a request for disabling an enabled profile as in operation 5140 as a method of determining processing of the enabled profile in the closed port.

If the terminal 5000 is configured to disallow an enabled state of a profile present in the closed port in operation 5140, the terminal 5000 may provide a screen indicating that the LPA of the terminal 5000 needs to perform profile disable processing such that the user may enter profile disable processing and may notify that disable processing needs to be performed to force the user to perform a profile disable operation. If the terminal 5000 is configured to allow the enabled state of the profile present in the closed port, the terminal 5000 may additionally display a screen requesting the user to perform disable processing of the enabled profile on the corresponding closed port, inducing the user to enter profile disable processing.

When the user selects to disable the enabled profile in the closed port in operation 5140, the terminal 5000 may transmit a processing command to disable the corresponding profile through an open ISD-R dedicated port if operating with MEP-A, or through one of open ports if operating with MEP-B. If the user selects to disable the profile in operation 5120, the LPA of the terminal 5000 or a SIM management app integrated with the LPA may combine a baseband connection state received from the terminal framework and profile state information acquired from the eUICC 5010 to configure an enabled state or a network disconnection state to be recognized by the user and may display or indicate the same on a user screen as in operation 5150. A procedure of performing, by the terminal 5000 and the eUICC 5100, profile disable processing in operation 5140 is processed based on detailed description of FIG. 4 and thus, further description related thereto is omitted in FIG. 5.

As described above with FIG. 4, option 1: processing a request for disabling a profile present in a closed port (operation 5140) may occur in the initialization process between the terminal 5000 and the eUICC 5010. Alternatively, after entering option 2 (operation 5150) and completing initialization while maintaining the enabled profile in the closed port as is without including profile disable processing between the terminal 5000 and the eUICC 5010, the user may provide an input that requests deactivation of the profile present in the closed port to the LPA of the terminal 5000 at a specific point in time such that the LPA requests the eUICC 5010 to disable the profile.

The modem (not shown) of the terminal 5000 that receives information from the eUICC 5100 delivers the information acquired from the eUICC 5100 to the framework (not shown) of the terminal 5000 to be used in an application of the terminal or a system. The modem (not shown) of the terminal 5000 may complete the initialization process by sequentially providing or combining information acquired at a specific point in time after a point in time at which the information is acquired from the eUICC 4010 and providing the same to be used in the application of the terminal 5000 or the system.

Although it is not illustrated in the drawings, which is the same as described above with FIG. 4, the terminal 5000 and the eUICC 5010 may use pre-agreed configuration. In this case, the negotiation procedure of operations 5040 and 5050 may be skipped. In this case, the terminal 5000 may proceed with operation 5060 using a preconfigured MEP mode to support, the number of openable ports for enabled profiles, and port number. The eUICC 5010 may proceed with operation 5070 by determining and having configuration as ISD-R approach with preconfigured information (number of openable ports for enabled profiles and port number are preconfigured in the eUICC 5010). Also, when the terminal 5000 and the eUICC 5100 are additionally configured to not support the enabled profile in the closed port, and here when the terminal 5000 desires to change the enabled profile with a physical SIM card and use the same in the eUICC 5010, the terminal 5000 may be configured to perform an operation of initially disabling a state of the enabled profile in an open port in MEP based on GSMA SGP.22 and then to perform an operation of processing a change to the physical SIM card. Alternatively, although not configured that way, the terminal 5000 may be configured to maintain and open the number of LSIs equal to the number of LSIs used in a previous card session at all times at a specific point after performing operation 5030 when performing the initialization procedure between the terminal 5000 and the eUICC 5100 (including rebooting). In this manner, the terminal 5000 may open ports for all of enabled profiles such that there is no enabled profile in the closed port as in operation 5120, or may not perform that way (operation 5130).

Meanwhile, although it is not illustrated in the drawings, the terminal 5000 and the eUICC 5010 may use pre-agreed configuration. In this case, the negotiation procedure of operations 5040 and 5050 may be skipped. In this case, the terminal 5000 may proceed with operation 5060 using a preconfigured MEP mode to support, the number of openable ports for enabled profiles, and port number. The eUICC 5010 may proceed with operation 5070 by determining and having configuration as preconfigured ISD-R approach. Also, when the terminal 5000 and the card 5100 are additionally configured to support the enabled profile in the closed port, and here when the terminal 5000 desires to change the enabled profile with a physical SIM card and use the same in the eUICC 5010, the terminal 5000 may be configured to perform an operation of initially disabling a state of the enabled profile in an open port in MEP based on GSMA SGP.22 and then to perform an operation of processing a change to the physical SIM card. Alternatively, although not configured that way, the terminal 5000 may be configured to change and open the number of LSIs different from (less than) the number of LSIs used in a previous card session at a specific point after performing operation 5030 when performing the initialization procedure between the terminal 5000 and the eUICC 5100 (including rebooting), and may be processed to enter operations 5140 to 5150 according to additional configuration of the terminal 5000.

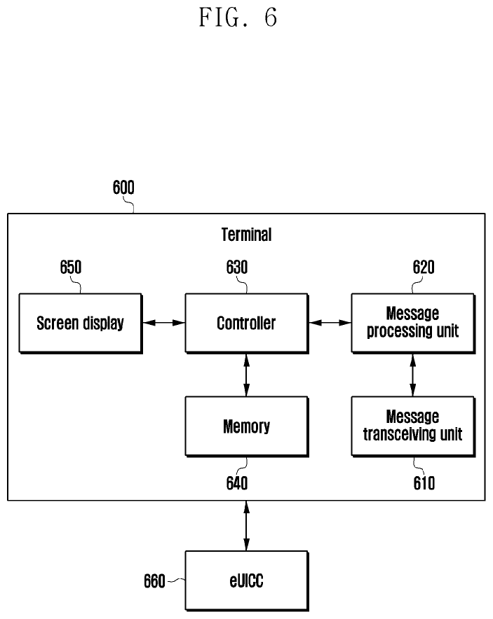

FIG. 6 is a diagram schematically illustrating an internal structure of a terminal in a wireless communication system according to an embodiment of the disclosure.

Referring to FIG. 6, a terminal 600 may include a message transceiver 610, a message processor 620, a controller 630, a memory 640, and a screen display 650. However, components of the terminal 600 are not limited to the above-described examples. For example, the terminal 600 may include the greater or smaller number of components than the number of the above-described components. In addition, at least one configuration of the terminal 600 may be implemented in a single chip form. According to some embodiments, the message transceiver 610 may function to transmit and receive signals through a wireless channel, such as band conversion and amplification of a signal. For example, the message transceiver 610 may include a radio frequency (RF) processor configured to up-convert a baseband signal to an RF band signal and to down-convert an RF band signal received through an antenna to a baseband signal, and may further include a transmit filter, a receive filter, an amplifier, a mixer, an oscillator, a digital-to-analog convertor (DAC), and an analog-to-digital convertor (ADC).

Also, the message transceiver 610 may receive a signal through a wireless channel and output the same to the processor 630, and may transmit a signal output from the controller 630 through the wireless channel. The message transceiver 610 may perform beamforming. For beamforming, the message transceiver 610 may adjust a phase and magnitude of each of signals transmitted and received through a plurality of antennas or antenna elements. Also, a baseband processor in the message transceiver 610 may perform a conversion function between a baseband signal and a bit string according to physical layer specifications of a system. For example, when transmitting data, the baseband processor generates complex symbols by encoding and modulating a transmission bit string. Also, when receiving data, the baseband processor restores a received bit string by demodulating and decoding a baseband signal provided from the RF processor. For example, according to an orthogonal frequency division multiplexing (OFDM) method, when transmitting data, the baseband processor may generate complex symbols by encoding and modulating the transmission bit string and may map the complex symbols to subcarriers and then configure OFDM symbols through an inverse fast Fourier transform (IFFT) operation and cyclic prefix (CP) insertion.

Also, when receiving data, the baseband processor may divide a baseband signal provided from the RF processor based on an OFDM symbol unit, may restore signals mapped to subcarriers through a fast Fourier transform (FFT) operation and then, may restore a received bitstream through demodulation and decoding.

The message transceiver 610 may be defined as a transceiver. A type and content of a message transmitted and received through the message transceiver 610 are not limited. The message processor 620 may perform an operation of determining a message corresponding to data that is transmitted or received through the message transceiver 610. For example, the message processor 620 may determine whether a received message is a control message of a radio resource control (RRC) layer (including a system information block (SIM)) or a user data message. The message processor 620 may be included in the controller 630.

The controller 630 may control overall operations of the terminal 600. For example, the controller 630 may transmit and receive signals through the message transceiver 610 and/or the message processor 620. Also, the controller 630 may record and read data in the memory 640. At least one controller 630 may be present. For example, the controller 630 may include a communication processor (CP) that performs control for communication and an application processor (AP) that controls an upper layer such as an application. According to some embodiments, when LSI configuration information is prestored in the memory 640, the controller 630 may request the corresponding information from the memory 640 to display the same on the screen display 850, or may receive the corresponding information to perform an additional operation.

The controller 630, the message processor 620, the message transceiver 610 may control the terminal 600 to connect to a selected provider network according to user or terminal settings. Also, according to some embodiments, the controller 630 may perform a process in which the terminal infers information usable for service selection by matching data recording that is read through the memory 640 or information that is collected through the controller 630, the message processor 620, and the message transceiver 610. According to some embodiments, the controller 630 may determine whether user consent is required for specific information stored in the terminal 600 and may display the same on the screen display 650. For example, the controller 630 may control a screen for user input to be generated and may control the generated screen to be displayed on the screen display 650.

Also, the controller 630 may control the terminal 600 to perform an operation corresponding thereto. According to some embodiments, the controller 630 may include an LPA responsible for driving and controlling an eUICC and an application in which the LPA is integrally implemented. Also, according to some embodiments, the controller 630 may include a terminal framework that interprets information received by the application or the LPA and processes a specific command APDU request in the CP or collects a portion or all of requested information from the memory 640 and returns the same to the LPA or the application.

The controller 630 may operate in a MEP mode by aggregating predetermined information acquired from the eUICC 660 through the terminal 600 and the message transceiver 610 and may determine an ISD-R approach and reply to the eUICC 660. The eUICC 660 is controlled by the controller 630 and according to an embodiment of the disclosure, the eUICC 660 may perform each management command and may deliver a proactive command to a modem and the like. To explain an operation between the terminal 600 and the eUICC to be distinguished from the LPA, the framework, and the modem included in the terminal 600, the eUICC 660 is indicated as a separate module outside the terminal in FIG. 6 and FIG. 1 described above. However, it should be noted that the eUICC 660 may be included and configured as a portion of the terminal 600 and a controller, a message processor, a memory, and a message transceiver may also be configured in the eUICC 660.

The memory 640 may store data, such as basic program, applications, and configuration information for operating the terminal 600. In an embodiment, the memory 640 may be configured with a storage medium such as read only memory (ROM), random access memory (RAM), hard disk, CD-ROM, and DVD or combination thereof and may provide stored data for Configure LSI in response to a request from the controller 630. Also, the memory 640 may be implemented by integrating the controller 630 and a system on chip (SoC).

Meanwhile, in an embodiment of the disclosure, the eUICC 660 is present as a separate module outside the terminal 600 and may insert into the terminal 600. The eUICC 660 may be configured to include some or all of other components excluding the screen display 650 from the module of the terminal 600. For example, according to an embodiment of the disclosure, the controller of the eUICC 660 may process and acquire Manage LSI (Configure LSI) information of the terminal 600 received through the message transceiver and then, may acquire predetermined information, such as an ISD-R approach and MEP support of the terminal, a supporting method, and the number of supportable ports, through the corresponding message information, may determine an operation with reference to an ISD-R approach supporting method jointly supportable by the eUICC 660 and whether MEP is supported, the number of jointly supportable ports, and the number of enabled profiles, and may also configure the right to enable a profile for each port, the right to allow an access to an ISD-R application ID (AID) for each port, and the right to access a profile for each port. Meanwhile, it should be noted that the terminal 600 may include UICC, eUICC, iSSP, and iUICC as embedded hardware security modules.

The screen display 650 may display information processed by the controller 630, or may display a progress process for an operation performed by the terminal 600 through processing of the controller 630 or consent to an event that requests the user to perform. According to some embodiments, stored profile information, displaying of a message for a closed profile, a profile disable request input, and input results may be displayed for the user as reply. According to some embodiments, the LPA or the application in which the LPA is integrally implemented may include the screen display 650 and the controller 630.

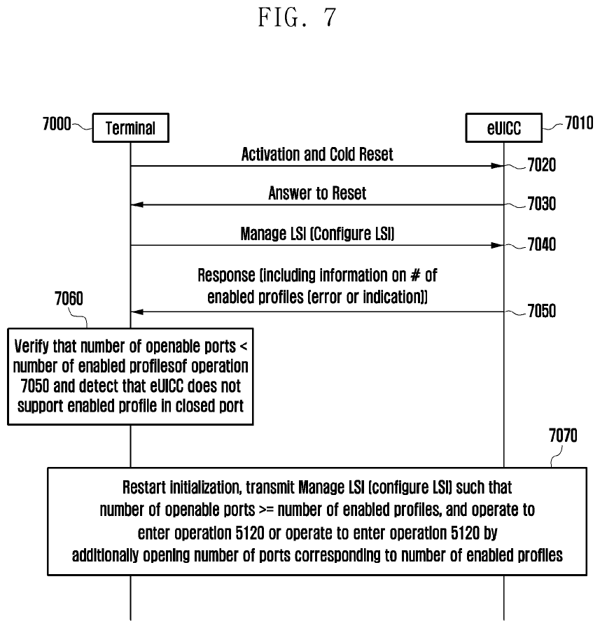

FIG. 7 illustrates an additional embodiment possible when an eUICC is an eUICC that does not support profile enabling in a closed port.

In FIGS. 4 and 5, the eUICC may be the eUICC that does not support profile enabling in the closed port. Describing by taking FIG. 5 as an example, the terminal 5000 in FIG. 5 may start initialization again without entering operation 5130 and may also enter operation 5120 (opening all ports for enabled profiles). FIG. 7 illustrates a corresponding procedure in detail.

As described above with reference to FIGS. 4 and 5, a terminal 7000 and an eUICC 7010 may start initialization by performing operations 7020 and 7030. After starting initialization, the terminal 7000 may transmit Manage LSI (Configure LSI) as described above in FIGS. 4 and 5 (operation 7040) to provide the number of LSI supported for a MEP mode supported by the terminal 7000 and enabled profiles to the eUICC 7010 (operation 7040). When the number of enabled profiles>the number of jointly supportable LSIs received in operation 7040, the eUICC 7010 that supports MEP may add, to response, or replace an error or a re-initialization indication (e.g., instead of the number of enabled profiles). Alternatively, regardless of the case in which the number of profiles>the number of jointly supportable LSIs received in operation 7040 or when the corresponding case occurs, indication as to whether an enabled profile is supported in a closed port may be added and replied (operation 7050).

The terminal 7000 may identify whether the number of openable ports<the number of enabled profiles through the message replied in operation 7050, and may detect that the eUICC 7010 does not support the enabled profile in the closed port (operation 7060). In this case, when the terminal 7000 is capable of further opening an additional port, the terminal 7000 may restart initialization and may transmit Manage LSI (Configure LSI) to the eUICC 7010 such that the number of openable ports>=the number of enabled profiles. Describing this by taking FIG. 5 as an example, by configuring an operation (operation 7070) to enter operation 5120, processing may be performed such that there is no enabled profile in the closed port. Alternatively, without restarting initialization, the terminal 7000 may transmit Manage LSI (Reset) Command to open an additional port to the eUICC 7010 such that the number of openable ports>=the number of enabled profiles. Describing this by taking FIG. 5 as an example, by configuring an operation (operation 7070) to enter operation 5120, processing may be performed such that there is no enabled profile in the closed port.

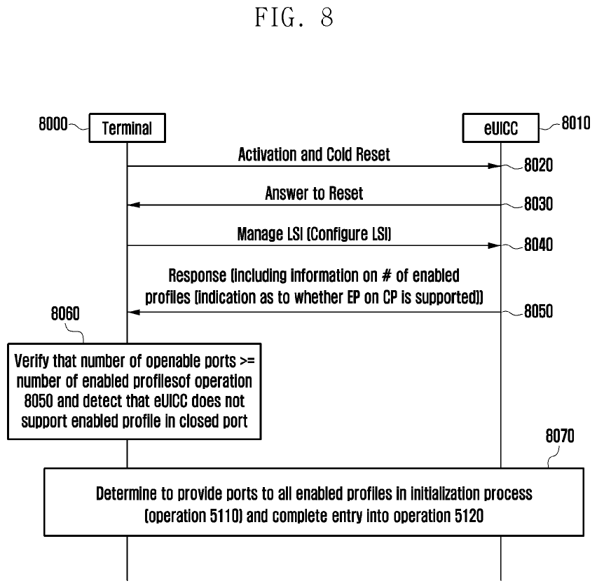

FIG. 8 illustrates an additional embodiment possible when an eUICC is an eUICC that does not support profile enabling in a closed port.

In FIGS. 4 to 5, the eUICC may be the eUICC that does not support profile enabling in the closed port. Describing by taking FIG. 5 as an example, when it is determined that the eUICC does not support the enabled profile in the closed port, the terminal 5000 may provide the number of enabled profiles or more to the eUICC 5010 at all times. FIG. 8 illustrates a corresponding procedure in detail.

As described above with reference to FIGS. 4 and 5, a terminal 8000 and an eUICC 8010 may start initialization by performing operations 8020 and 8030. After starting initialization, the terminal 8000 may transmit Manage LSI (Configure LSI) as described above with reference to FIGS. 4 and 5 (operation 8040) to provide the number of LSIs supported for a MEP mode supported by the terminal 8000 and enabled profiles to the eUICC 8010 (operation 8040). The eUICC 8010 that supports MEP may add, to enabled profile information, and reply with indication as to whether an enabled profile is supported in the closed port (EP on a CP: enabled profile in a closed port) (operation 8050).

Meanwhile, FIG. 5 shows that a form of Table 6 is included as an example of the response message of the eUICC 5010 to Table 5. Here, when the indication is added, an example may include a form as disclosed in Table 7 below.

TABLE 7

| Byte(s) | Description | Value | Length |
|---|---|---|---|
| 1 | Tag for MEP modes | ′90′ | 1 |
| 2 | Length of next field | 1 + M | 1 |
| 3 | Jointly supported MEP mode, coding see table | — | 1 |
| | above | | |
| | Set to ′00′ in case of no jointly supported | | |
| | MEP mode. | | |
| 4 to M + 3 | All MEP modes supported by the UICC (including | — | M |
| | the mode given in byte 3 in arbitrary order, | | |
| | coding see table above | | |
| M + 4 | Tag for jointly supported maximum number of | ′91′ | 1 |
| | LSIs for Enabled Profiles | | |
| M + 5 | Length of next field | 3 + X | 1 |
| M + 6 | Maximum number of LSIs jointly supported for | — | 1 |
| | Enabled Profiles | | |
| M + 7 | Number of currently Enabled Profiles | — | 1 |
| M + 8 to | Port number in ascending order associated to | — | X = the Value |
| M + X | the Enabled Profiles indicated in the M + 7 | | of M + 7 |
| M + X + 1 | Indication of EP on a CP(Enabled Profile on a | — | 1 |
| | Closed Port) support | | |

The terminal 7000 may identify whether the number of openable ports>=the number of enabled profiles through the message replied in operation 8050, and may detect that the eUICC does not support the enabled profile in the closed port (operation 8060). In this case, the terminal 8000 may determine to provide ports to all enabled profiles in an initialization process (operation 5110 of FIG. 5) and may complete entry (operation 8070) such that there is no enabled profile in the closed port (in operation 5120 of FIG. 5), thereby completing the initialization procedure. Meanwhile, although FIGS. 7 and 8 are described using the example of FIG. 5, this may also be applied equally even to FIG. 4. In this case, in operation 4090 of FIG. 4, indication as to whether an enabled profile is supported in a closed port or an error and a re-initialization indication may be included as a value of the ISD-R template and replied.

The present invention, in a method performed by a terminal in a wireless communication system, includes generating a first message that includes an ISD-R approach supportable by the terminal and the number of ports supported for enabled profiles; transmitting the first message to the security module; and receiving a second message from the security module in response to the first message.

In the method performed by the terminal in the wireless communication system, some examples may provide a method and apparatus for receiving, from the security module, a message that includes a profile management command approach jointly supportable with the terminal, the number of jointly supportable ports, and the number of enabled profiles additionally stored in the security module or/and the number of profiles as the second message, determining the number of ports to be opened for profile enabling and port number, and not processing a profile to which a port is not allocated when the number of openable ports is smaller than the number of enabled profiles received through the second message.

As another example of the present invention, a method performed by a security module in a wireless communication system includes receiving, from a terminal, a first message for a supportable profile management command approach and the number of ports to be supported; and, in response to the first message, transmitting, to the terminal, a second message that includes a jointly supportable profile management command approach, the number of jointly supportable ports for profile enabling, and the number of enabled profiles stored in the security module or/and the number of profiles, and the first message is generated based on configuration information of the terminal.

As another example of the present invention, a method performed by a security module in a wireless communication system includes receiving, from a terminal, a message related to a supportable profile management command approach and the number of ports to be supported; and in response to the first message, transmitting, to the terminal, a second message that includes the number of jointly supportable ports and further receiving a third message additionally received from the terminal; and further providing the number of enabled profiles stored in the security module or/and the number of profiles as a fourth message replied to the corresponding message.

In another example of the present invention, a method of processing, by the terminal, a corresponding enabled profile when the number of ports to be opened for profile enabling in the terminal is less than the number of enabled profiles in the security module using the second message received from the security module or combination of the second message and the fourth message may include a configuration method of maintaining and processing at least one of configuration modules of the terminal described with FIG. 1 in a corresponding activation state to request and process a profile disable command from the eUICC or to maintain and process the activation state of the profile in the closed port.

In another example of the present invention, by referring to the number of port open commands (number of Manage LSI (reset) Commands) received from the terminal for activation of the profile at a specific point in time after the first message is received by the security module from the terminal and after the security module returns the second or fourth message to the terminal, if the number of port open commands is less than the number of enabled profiles, reception of a request command to disable an enabled profile in a closed port with one of open ports is allowed and configuration may be provided and processed to process the same by additionally referring to the approach mentioned in FIG. 3.

Technical subjects to be achieved by the disclosure are not limited to the above-described technical subjects and still other technical subjects not mentioned may be clearly understood by one of ordinary skill in the art to which the disclosure pertains from the following description.

Through embodiments disclosed herein, when it is determined to enter a MEP mode between a terminal and a card and the number of ports to be opened are generated to exchange messages between the terminal and the card, the following may be expected.

When a management message, such as enable/disable of a telecommunication company profile, is transmitted from a terminal to an eUICC through one physical pin, the terminal and the eUICC may process profile management by distinguishing profiles through a logical interface although a plurality of telecommunication company profiles is present in the eUICC. Also, the terminal may determine to process a management command by mapping the telecommunication company profile to a corresponding baseband of the terminal. Also, through this, since the user may simultaneously use profiles of various telecommunication companies in the terminal equipped with one eUICC, user convenience may be improved. For example, when traveling overseas, the user may simultaneously use the existing domestic telecommunication company profile and a local profile at a travel destination with one eUICC and may also domestically use two profiles of the same telecommunication company with one eUICC by differentiating subscription. A terminal manufacturer may provide a dual SIM function without an additional terminal mounting space by connecting one eUICC to a modem (that provides two or more basebands) through one physical pin. Here, although it is mentioned as a dual SIM, it should be noted that it may be used as a triple, quadruple SIM function depending on the number of available basebands.

Also, when the terminal does not provide a path for transmitting and receiving messages to and from the terminal to the eUICC for enabled profile(s), the terminal may ultimately configure and provide information on availability of an accurate profile to the user by defining operation and processing of the terminal that processes the enabled terminal in the closed port.

A terminal according to various embodiments disclosed herein may be an electronic device, and the electronic device may be a device in various forms. The electronic device may include, for example, a portable communication device (e.g., smartphone), a computer device, a portable multimedia device, a portable medical device, a camera, a wearable device, or a home appliance device. The electronic device according to an embodiment herein is not limited to the above-described devices.

Various embodiments and terms used herein are not construed to limit technical features disclosed herein to specific embodiments, and should be understood to include various modifications, equivalents, or substitutions of a corresponding embodiment. In describing drawings, like reference numerals refer to like components. The singular forms “a,” “an,” and “the” of noun corresponding to an item are intended to include one item or a plurality of items, unless the context clearly indicates otherwise. Herein, each of the expressions, “A or B,” “at least one of A and B,” “at least one of A or B,” “A, B, or C,” “at least one of A, B, and C,” “at least one of A, B, or C,” and the like may include any possible combinations of items listed with a corresponding expression among the expressions. Terms “first,” “second,” etc., are simply used to distinguish one component from another component and do not limit the corresponding components in another aspect (e.g., importance or order). When a (e.g., first) component is described to be “coupled” or “connected to” another (e.g., second) component along with the term “functionally” or “communicatively,” the component may be directly (e.g., wiredly) connected to the other component or may be connected through a third component.

The term “module” used herein may include a unit implemented as hardware, software, or firmware, and may be interchangeably used with the terms, for example, logic, logic block, part, and circuit. The module may be an integrally configured part or a minimal unit of the part that performs one or more functions or a portion thereof. For example, according to an embodiment, the module may be implemented in a form of an application-specific integrated circuit (ASIC).

Various embodiments disclosed herein may be implemented as software (e.g., program) that includes one or more commands stored in a storage medium (e.g., internal memory or external memory) readable by a machine (e.g., electronic device). For example, a processor of the machine (e.g., electronic device) may call and execute at least one command among the one or more commands stored in the storage medium, which enables the device to operate to perform at least one function in response to the called at least one command. The one or more commands may include a code generated by a compiler or a code executable by an interpreter. The storage medium readable by the device may be provided in the form of a non-transitory storage medium. Here, “non-transitory” simples indicates that the storage medium is a tangible device and does not include a signal (e.g., electromagnetic wave). This term does not distinguish a case in which data is semi-permanently stored in the storage medium from a case in which the data is transitorily stored in the storage medium.

According to an embodiment, the method according to various embodiments disclosed herein may be included in a computer program product and thereby provided. The computer program product may be traded between a seller and a purchaser. The computer program product may be distributed in a form of a storage medium readable by machine (e.g., compact disc read only memory (CD-ROM)) or may be distributed (e.g., downloaded or uploaded) directly or online through an application store (e.g., PlayStore™) or between two user devices (e.g., smartphones). In the case of online distribution, at least a portion of the computer program product may be at least transitorily stored or temporarily generated in a server of a manufacturer, a server of application store, or a storage medium readable by machine such as a memory of a repeater server.

According to various embodiments, a component (e.g., module or program) of each of the above-described components may include a singular object or a plurality of objects. According to various embodiments, one or more components among the above-described components or operations may be omitted, or one or more other components or operations may be added. Approximately or additionally, the plurality of components (e.g., module or program) may be integrated into one component. In this case, the integrated component may perform one or more functions of each of the plurality of components identically or similarly as being performed by a corresponding component among the plurality of components before the integration. According to various embodiments, operations performed by a module, a program, or another component may be executed sequentially, in parallel, repeatedly, or heuristically, or at least one of the operations may be executed in different order or omitted. Alternatively, one or other operations may be added.

In detailed embodiments of the disclosure described above, a component included in the disclosure is expressed in a singular or plural form depending on the presented detailed embodiments. However, the singular or plural expression is selected to be suitable for a presented situation for convenience of description. The disclosure is not limited to a singular component or a plurality of components. Even a component expressed in the plural form may be configured to be singular, or a component expressed in the singular form may be configured to be plural.

Meanwhile, although specific embodiments have been described in the detailed description of the disclosure, various modifications may be made without departing from the scope of the disclosure. Therefore, the scope of the disclosure should not be limited to the described embodiments and should be defined by the claims and equivalents thereof.

1. A method performed by a terminal in a wireless communication system, the method comprising:
in case that the terminal supports multiple enabled profiles (MEP), identifying the number of ports supportable between the terminal and an enabled universal integrated circuit card (eUICC);
identifying the number of enabled profiles among a plurality of profiles of the eUICC;
in case that the identified number of ports is less than the number of enabled profiles, determining to disable at least one profile among the enabled profiles; and
delivering a command to disable the at least one profile to the eUICC.

2. The method of claim 1, wherein the delivering further comprises in case that the plurality of profiles includes a first profile and a second profile, a local profile assistant (LPA) of the terminal and an application corresponding to the first profile share a first port, the LPA and an application corresponding to the second profile share a second port, and the first port is not a supportable port and thus, the enabled first profile mapped to the first port is to be disabled, delivering a command to disable the first profile through the second port.

3. The method of claim 1, wherein the delivering further comprises in case that the plurality of profiles includes a first profile and a second profile, a third port corresponding to an LPA of the terminal is present separate from a first port corresponding to the first profile and a second port corresponding to the second profile, and the first port is not a supportable port and thus, the enabled first profile mapped to the first port is to be disabled, delivering a command to disable the first profile through the third port.

4. The method of claim 1, wherein the identifying the number of supportable ports further comprises:
transmitting, to the eUICC, a first message that includes at least one of MEP mode information supportable by the terminal and information on the maximum number of ports for the enabled profiles of the terminal; and
receiving, from the eUICC, a second message that includes information on the number of ports jointly supportable by the terminal and the eUICC as a response to the first message.

5. The method of claim 1, wherein the identifying the number of enabled profiles further comprises:
transmitting, to the eUICC, a message that requests MEP configuration information; and
receiving, from the eUICC, a third message that includes at least one of information on the number of enabled profiles and number information of a port corresponding to the enabled profile based on the request message.

6. The method of claim 1, wherein the command to disable the at least one profile is delivered from an LPA of the terminal to Issuer Security Domain Root (ISD-R) of the eUICC.

7. The method of claim 1, wherein the determining further comprises displaying information on deactivation of the at least one profile, and
in case that a user command to disable the at least one profile is input based on the displayed information, the at least one profile is determined to be disabled.

8. A terminal in a wireless communication system, the terminal comprising:
a transceiver; and
a controller configured to, in case that the terminal supports multiple enabled profiles (MEP), identify the number of ports supportable between the terminal and an embedded universal integrated circuit card (eUICC), to identify the number of enabled profiles among a plurality of profiles of the eUICC, to if the verified number of ports is less than the number of enabled profiles, determine to disable at least one profile among the enabled profiles, and to control to deliver a command to disable the at least one profile to the eUICC.

9. The terminal of claim 8, wherein the controller is further configured to, in case that the plurality of profiles includes a first profile and a second profile, a local profile assistant (LPA) of the terminal and an application corresponding to the first profile share a first port, the LPA and an application corresponding to the second profile share a second port, and the first port is not a supportable port and thus, the enabled first profile mapped to the first port is to be disabled, deliver a command to disable the first profile through the second port.

10. The terminal of claim 8, wherein the controller is further configured to, in case that the plurality of profiles includes a first profile and a second profile, a third port corresponding to an LPA of the terminal is present separate from a first port corresponding to the first profile and a second port corresponding to the second profile, and the first port is not a supportable port and thus, the enabled first profile mapped to the first port is to be disabled, deliver a command to disable the first profile through the third port.

11. The terminal of claim 8, wherein the controller is further configured to transmit, to the eUICC, a first message that includes at least one of MEP mode information supportable by the terminal and information on the maximum number of ports for the enabled profiles of the terminal, and to receive, from the eUICC, a second message that includes information on the number of ports jointly supportable by the terminal and the eUICC as a response to the first message.

12. The terminal of claim 8, wherein the controller is further configured to transmit, to the eUICC, a message that requests MEP configuration information, and to receive, from the eUICC, a third message that includes at least one of information on the number of enabled profiles and number information of a port corresponding to the enabled profile based on the request message.

13. The terminal of claim 8, wherein the command to disable the at least one profile is delivered from an LPA of the terminal to Issuer Security Domain Root (ISD-R) of the eUICC.

14. The terminal of claim 8, further comprising:
a screen display,
wherein the controller is further configured to control the screen display to display information on deactivation of the at least one profile, and
in case that a user command to disable the at least one profile is input based on the displayed information, the at least one profile is determined to be disabled.
